(19) United States
(12) Patent Application Publication
(10) Pub. No.: US 2017/0160783 A1
(43) Pub. Date: Jun. 8, 2017

(54) INFORMATION PROCESSING APPARATUS, ARITHMETIC PROCESSING DEVICE, AND METHOD OF CONTROLLING INFORMATION PROCESSING APPARATUS

(71) Applicant: FUJITSU LIMITED, Kawasaki-shi (JP)

(72) Inventor: Yukihito Kawabe, Kawasaki (JP)

(73) Assignee: FUJITSU LIMITED, Kawasaki-shi (JP)

(21) Appl. No.: 15/293,672

(22) Filed: Oct. 14, 2016

(30) Foreign Application Priority Data
Dec. 3, 2015 (JP) 2015-236829

(51) Int. Cl. G06F 1/32

(52) U.S. Cl. CPC G06F 1/324; G06F 1/3296; G06F 1/3206

(57) ABSTRACT

An information processing apparatus includes processing devices including: an arithmetic processing circuit for executing arithmetic processing and generating a plurality of event signals corresponding to events executed in the arithmetic processing; a plurality of coefficient value holding circuitry respectively for holding a coefficient value corresponding to any one of events to be executed by the arithmetic processing circuit; an accumulated value holding circuit for holding an accumulated value obtained by using one or more of the coefficient values held by specified coefficient value holding circuitry corresponding to the event signals; a power upper limit holding circuit for holding power upper limits of each processing device which correspond to a power upper limit of the information processing apparatus; and a control circuit for controlling at least one of a voltage and a frequency of each of the processing devices such that the accumulated value does not exceed the power upper limit.

### CROSS-REFERENCE TO RELATED APPLICATION

This application is based upon and claims the benefit of priority of the prior Japanese Patent Application No. 2015-236829, filed on Dec. 3, 2015, the entire contents of which are incorporated herein by reference.

### FIELD

The embodiments discussed herein are related to an information processing apparatus, an arithmetic processing device, and a method of controlling an information processing apparatus.

### BACKGROUND

In recent years, with an increase of power consumption of an arithmetic processing device, power consumption of information processing apparatus such as a parallel computer and the like used for high performance computing (HPC) tends to be increased. Along with this tendency, an operation technique of managing power consumption of an arithmetic processing device and suppressing power consumption of a parallel computer on which an arithmetic processing device is mounted has become important.

For example, a change in power consumed by an arithmetic processing device is estimated by receiving event signals corresponding to various events executed in the arithmetic processing device, weighting and integrating values of the received event signals, and periodically reading the integrated values. In addition, the power consumption of the arithmetic processing device is managed by adjusting a clock frequency based on the change in the estimated power. Moreover, the power consumption of the arithmetic processing device is managed by detecting various events having occurred in an arithmetic core mounted on the arithmetic processing device through a bus and executing a power sequence based on the detected events.

In addition, the power consumption of the arithmetic processing device is estimated by counting the number of times of occurrences of events affecting power consumption of the arithmetic processing device and integrating a value obtained by multiplying the counted value by a weighting coefficient for each predetermined period. The estimated power consumption is then corrected by the static power value, the temperature, or the voltage of the arithmetic processing device and is used as an estimated value of power actually consumed by the arithmetic processing device.

As examples of the related art, Japanese Laid-open Patent Publication No. 2008-140380, Japanese Laid-open Patent Publication No. 2008-165797, U.S. Pat. No. 8,650,413, and IBM j. RES. & DEV. VOL. 55 NO. 3 PAPER 8 MAY/JUNE 2011 are known.

### SUMMARY

According to an aspect of the invention, an information processing apparatus includes a plurality of arithmetic processing devices. The arithmetic processing device includes: an arithmetic processing circuit configured to execute arithmetic processing and generate a plurality of event signals corresponding to events executed in the arithmetic processing; a plurality of coefficient value holding circuitry respectively configured to hold a coefficient value corresponding to any one of events to be executed by the arithmetic processing circuit; an accumulated value holding circuit configured to hold an accumulated value obtained by using one or more of the coefficient values held by specified coefficient value holding circuitry from among the plurality of coefficient value holding circuitry, the specified coefficient value holding circuitry corresponding to the plurality of event signals generated by the arithmetic processing circuit; a power upper limit holding circuit configured to hold power upper limits of each arithmetic processing device which correspond to a system power upper limit which is the power upper limit of the information processing apparatus; and a control circuit configured to control at least one of a voltage and a frequency of each of the arithmetic processing devices such that the accumulated value held by the accumulated value holding circuit does not exceed the power upper limit held by the power upper limit holding circuit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an embodiment of an information processing apparatus, an arithmetic processing device, and a method of controlling an information processing apparatus;

FIGS. 2A to 2C are diagrams illustrating an example of an operation of the arithmetic processing device illustrated in FIG. 1;

FIG. 3 is a diagram illustrating another example of an information processing apparatus;

FIGS. 4A and 4B are diagrams illustrating an example of an operation of the arithmetic processing device illustrated in FIG. 3;

FIGS. 5A and 5B are diagrams illustrating an example of synchronous processing executed by the information processing apparatus illustrated in FIG. 1 and the information processing apparatus illustrated in FIG. 3;

FIG. 6 is a diagram illustrating still another embodiment of an information processing apparatus, an arithmetic processing device, and a method of controlling an information processing apparatus;

FIG. 7 is a diagram illustrating an example of a power monitor unit illustrated in FIG. 6;

FIG. 8 is a diagram illustrating an example of a power accumulation unit illustrated in FIG. 7;

FIG. 9 is a diagram illustrating an example of an operation of a power capping control unit illustrated in FIG. 6;

FIG. 10 is a diagram illustrating an example of a power capping operation by DFS control of a voltage frequency control unit illustrated in FIG. 6;

FIG. 11 is a diagram illustrating an example of a power capping operation by DVFS control of the voltage frequency control unit illustrated in FIG. 6;

FIG. 12 is a diagram illustrating still another example of an information processing apparatus;

FIG. 13 is a diagram illustrating an example of the configuration and the electrical characteristic of the information processing apparatus illustrated in FIGS. 6 and 12;

FIG. 14 is a diagram illustrating an example of an operation model of an arithmetic processor illustrated in FIGS. 6 and 12;

FIG. 15 is a diagram illustrating an example of the processing time of the arithmetic processor illustrated in FIGS. 6 and 12;

FIG. 16 is a diagram illustrating an example of a service processor according to still another embodiment of an information processing apparatus, an arithmetic processing device, and a method of controlling an information processing apparatus;

FIG. 17 is a diagram illustrating an example of an arithmetic processor according to still another embodiment of an information processing apparatus, an arithmetic processing device, and a method of controlling an information processing apparatus;

FIG. 18 is a diagram illustrating an example of a service processor connected to the arithmetic processor illustrated in FIG. 17;

FIG. 19 is a diagram illustrating an example of a variation index value conversion table illustrated in FIG. 18;

FIG. 20 is a diagram illustrating an example of an operation of a coefficient value generation unit illustrated in FIG. 18;

FIG. 21 is a diagram illustrating an example of internal division processing executed in Step S308 illustrated in FIG. 20;

FIG. 22 is a diagram illustrating an example of an operation of a system static power generation unit illustrated in FIG. 18;

FIG. 23 is a diagram illustrating an example of internal division processing executed in Step S408 illustrated in FIG. 22;

FIG. 24 is a diagram illustrating an example of a service processor according to still another embodiment of an information processing apparatus, an arithmetic processing device, and a method of controlling an information processing apparatus;

FIG. 25 is a diagram illustrating an example of a system static power conversion table illustrated in FIG. 24;

FIG. 26 is a diagram illustrating an example of an operation of a system static power value correction unit illustrated in FIG. 24;

FIG. 27 is a diagram illustrating an example of a method of creating information stored in the system static power conversion table illustrated in FIG. 24,

FIG. 28 is a diagram illustrating an example of a service processor according to still another embodiment of an information processing apparatus, an arithmetic processing device, and a method of controlling an information processing apparatus; and

FIG. 29 is a diagram illustrating an example of an operation of a power control unit illustrated in FIG. 28.

### DESCRIPTION OF EMBODIMENTS

In the related art, in order to suppress power consumption of a parallel computer on which an arithmetic processing device is mounted, power capping that adjusts the clock frequency of the arithmetic processing device is executed using an estimated value of power actually consumed by the arithmetic processing device. Since the power consumption of an arithmetic processing device varies due to a variation in electrical characteristic of an arithmetic processing device, the execution timing (timing of changing the clock frequency) of power capping is different for each arithmetic processing device. The processing time for arithmetic processing in parallel processing of an arithmetic processing device in which the clock frequency is lowered is different from the processing time for arithmetic processing in arithmetic processing of an arithmetic processing device in which the clock frequency is not lowered. For this reason, an arithmetic processing device that has completed arithmetic processing first waits for synchronization, that is, waits for start of the next arithmetic processing until arithmetic processing during execution by another arithmetic processing device is completed. The start timing of the next arithmetic processing is adjusted for an arithmetic processing device executing arithmetic processing for the longest processing time. Accordingly, in the related art, in a case where power capping is performed using an estimated value of power actually consumed by an arithmetic processing device, there is a technical problem in that processing performance of a parallel computer is degraded even though power consumption is suppressed.

As one aspect of the present embodiment, provided are solutions for being able to suppress power consumption and suppress degradation of processing performance.

Hereinafter, embodiment will be described with reference to the accompanying drawings.

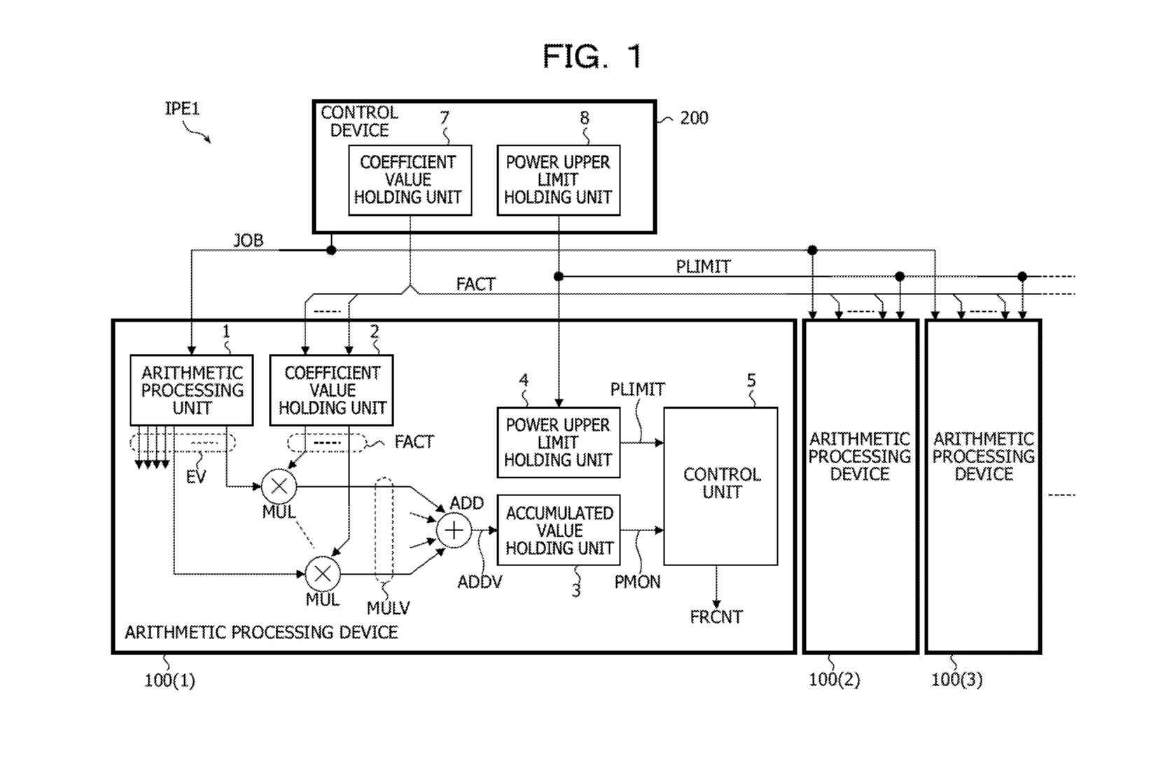

FIG. 1 illustrates an embodiment of an information processing apparatus, an arithmetic processing device, and a method of controlling an information processing apparatus. An information processing apparatus IPE1 illustrated in FIG. 1 includes a plurality of arithmetic processing devices 100 (100 (1), 100 (2), and 100 (3)) and a control device 200 that controls an operation of the arithmetic processing devices 100. For example, the information processing apparatus IPE1 is used in the field of high performance computing (HPC), divides job JOB (data) into plural pieces, and outputs the divided job JOB to the plurality of arithmetic processing devices 100. The plurality of arithmetic processing devices 100 executes received job JOB in parallel. That is, the information processing apparatus IPE1 functions as a parallel computer. Since the arithmetic processing devices 100 (1), 100 (2), and 100 (3) have configurations which are the same as or similar to each other, the arithmetic processing device 100 (1) will be described below.

The arithmetic processing device 100 (1) includes an arithmetic processing unit (arithmetic processing circuitry) 1, a coefficient value holding unit (coefficient value holding circuitry) 2, an accumulated value holding unit (accumulated value holding circuitry) 3, a power upper limit holding unit (power upper limit holding circuitry) 4, and a control unit (control circuitry) 5. The arithmetic processing unit 1 executes arithmetic processing for processing job (divided data) input from the control device 200 and outputs an event signal EV (for example, logic 1) that indicates execution of arithmetic processing. In other words, the arithmetic processing unit 1 may be configured to execute arithmetic processing and generate a plurality of event signals corresponding to events executed in the arithmetic processing 1. Each unit included in the arithmetic processing device 100 may be formed as a hardware circuit or circuitry.

The event signal EV indicates occurrence of arithmetic processing (event such as addition processing or multiplication processing) respectively executed by a computing element such as a fixed point arithmetic element or a floating point arithmetic element. A plurality of events includes a target event which is an event having a deep relationship with power consumption and a non-target event which is an event having a shallow relationship with power consumption, and the event signal EV corresponding to the target event is output to a multiplier MUL for calculating power consumption (estimated value).

For example, the amount of power consumed by execution of a target event is larger than the amount of power consumed by execution of a non-target event and affects power consumption of the entire arithmetic processing device. Therefore, a target event is important for calculating power consumption of the arithmetic processing device. Meanwhile, the power consumed by execution of a non-target event less affects power consumption of the entire arithmetic processing device and the non-target event can be excluded from calculation of power consumption of the arithmetic processing device.

The coefficient value holding unit 2 holds a plurality of coefficient values FACT respectively corresponding to target events among events occurring in the arithmetic processing unit 1 and the coefficient values FACT held by the coefficient value holding unit 2 are respectively output to the corresponding multiplier MUL. Moreover, the plurality of coefficient values FACT may be held by a plurality of coefficient value holding units 2. In other words, each of the plurality of coefficient value holding units 2 may be configured to hold a coefficient value corresponding to any one of events to be executed by the arithmetic processing unit 1.

For example, since the power consumption of a floating point computing element is larger than the power consumption of a fixed point arithmetic element, a coefficient value FACT corresponding to the floating point arithmetic is larger than a coefficient value FACT corresponding to the fixed point arithmetic. That is, a coefficient value FACT indicates weighting for converting a logic 1 (value “1”) of the corresponding event signal EV to power consumed by arithmetic processing (event) which is the cause of generation of an event signal EV. For example, each coefficient value FACT is commonly set by a plurality of arithmetic processing devices 100. Each coefficient value FACT is stored in the coefficient value holding unit 2 by the control device 200.

Each multiplier MUL outputs an integrated value MULV obtained by multiplying the value (“1” or “0”) of the event signal EV by the coefficient value FACT to an adder ADD. In other words, the coefficient value FACT is selected by multiplying the value “1” of the event signal EV and is treated as the integrated value MULV. Namely, one or more of specified holding circuitry are selected, by multiplying the value “1” of the event signal EV, from among the plurality of coefficient value holding circuitry. Each integrated value MULV indicates power to be consumed by the arithmetic processing devices 100, having an average electrical characteristic (hereinafter, referred to as a standard arithmetic processing device) among the plurality of arithmetic processing devices 100 amounted on the information processing apparatus IPE1, by one event. The adder ADD adds the integrated value MULV to be output from the multiplier MUL and outputs the added value ADDV obtained by the addition to the accumulated value holding unit 3. For example, multiplication using the multiplier MUL and addition using the adder ADD are executed for each clock cycle and the added value ADDV indicates power (dynamic power which does not include static power such as leakage power) to be consumed by the standard arithmetic processing device for each clock cycle.

The accumulated value holding unit 3 accumulates the added value ADDV for a predetermined period and holds the value. In other words, the accumulated value holding unit 3 holds an accumulated value obtained by using one or more of the coefficient values held by the specified coefficient value holding unit from among the plurality of coefficient value holding unit. The accumulated value holding unit 3 outputs the accumulated value to the control unit 5 as a monitor value PMON of dynamic power for each predetermined period. The monitor value PMON is an example of the accumulated value obtained by respectively adding integrated values of values of the event signals EV and the coefficient values FACT. The monitor value PMON indicates the value of power (average value of dynamic power to be consumed by the plurality of arithmetic processing devices 100) to be consumed by the standard arithmetic processing device for a predetermined period and is different from the value of power to be actually consumed by the arithmetic processing device 100 (1) for a predetermined period. In other words, the coefficient value FACT is set such that the dynamic power consumed by the standard arithmetic processing device is represented by the monitor value PMON.

Further, the arithmetic processing unit 1 may accumulate values of the event signals EV corresponding to target events using a counter or the like for a predetermined period in place of the accumulated value holding unit 3 accumulating the added values ADDV for each clock cycle for a predetermined period. Further, the number of target events which is the accumulated values of the event signals EV and the coefficient values FACT may be multiplied using a multiplier MUL. In this case, the accumulated value holding unit 3 holds the added value ADDV indicating dynamic power to be consumed by the standard arithmetic processing device for a predetermined period and outputs the held added value ADDV to the control unit 5 as the monitor value PMON. In a case where the values of the event signals EV are accumulated, since a counter or the like is provided for each event signal, the circuit scale becomes larger compared to the case where the added values ADDV are accumulated by the accumulated value holding unit 3.

The power upper limit holding unit 4 holds a power upper limit PLIMIT (common to the plurality of arithmetic processing devices 100) which is the maximum value of dynamic power equally allocated to each arithmetic processing device 100. The power upper limit PLIMIT is stored in the power upper limit holding unit 4 by the control device 200.

For example, the power upper limit value PLIMIT is calculated by dividing a value, obtained by subtracting the value of system static power value (leakage power value) to be consumed by the information processing apparatus IPE1 from the system power upper limit which is the maximum value of power that can be consumed by the information processing apparatus IPE1, by the number of arithmetic processing devices 100. Hereinafter, the value obtained by subtracting the system static power value from the system power upper limit is referred to as a system dynamic power upper limit. Here, it is assumed that the number of transistors to be mounted on the arithmetic processing devices 100 is dominant in the information processing apparatus IPE1. In this case, the total values of system static power to be consumed by each arithmetic processing device 100 of the information processing apparatus IPE1 can be used as the value of system static power to be consumed by the information processing apparatus IPE1. For example, the value of system static power to be consumed by the information processing apparatus IPE1 is acquired by multiplying the value of static power to be consumed by the standard arithmetic processing device by the number of arithmetic processing devices 100 to be mounted on the information processing apparatus IPE1.

The value of system static power to be consumed by the information processing apparatus IPE1 fluctuates by the chip temperature of a processor 100. However, the system static power value used for calculation of the power upper limit PLIMIT may be a value in a case where dynamic power in the vicinity of the power upper limit PLIMIT is consumed at the chip temperature.

The control unit 5 controls at least one of the frequency and the power supply voltage of the arithmetic processing device 100 (1) such that the monitor value PMON generated for each predetermined period does not exceed the power upper limit PLIMIT. In the example illustrated in FIG. 1, the control unit 5 performs so-called power capping by generating a frequency control signal FRCNT that controls the frequency of the arithmetic processing device 100 (1) such that the monitor value PMON generated for each predetermined period does not exceed the power upper limit PLIMIT. The frequency control signal FRCNT is supplied to a clock generation circuit such as a phase locked loop (PLL). For example, the control unit 5 outputs the frequency control signal FRCNT for lowering the clock frequency which operates the arithmetic processing device 100 (1) when the monitor value PMON exceeds the power upper limit PLIMIT. That is, the control unit 5 performs dynamic frequency scaling (DFS) that changes the clock frequency according to the state of the operation of the arithmetic processing device 100 (1).

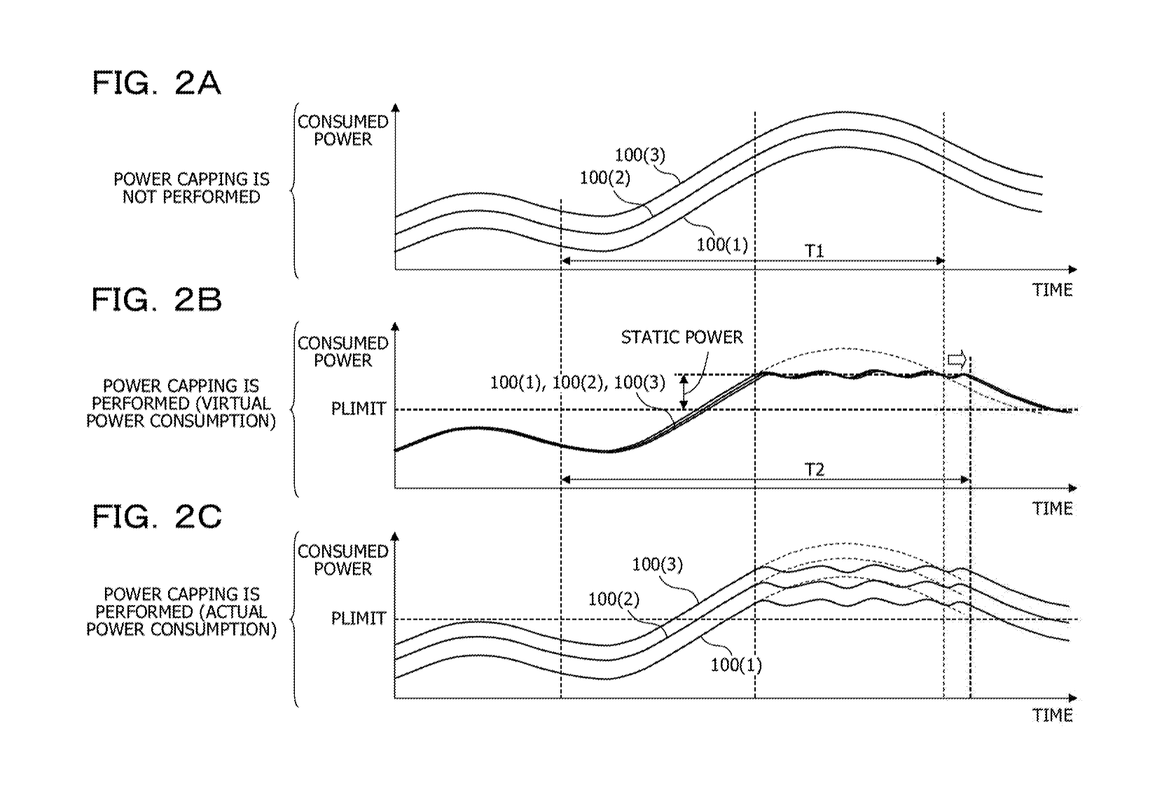

Moreover, in a case of lowering the clock frequency, the control unit 5 may perform control (dynamic voltage and frequency scaling (DVFS)) of lowering the power supply voltage to be supplied to the arithmetic processing devices 100 together with the clock frequency. Here, since the dynamic power of the arithmetic processing devices 100 changes in proportion to the square of the amount of change in power supply voltage, it is preferable that the accumulated value holding unit 3 corrects the monitor value PMON according to the fluctuation of the power supply voltage in the case of performing DVFS control. In this manner, in the case of performing DVFS control, an error in processing time T2 among the plurality of arithmetic processing devices 100 in FIG. 2B described below can be reduced compared to a case where the monitor value PMON is not corrected. Further, the arithmetic processing device 100 (1) may include a correction unit that corrects the monitor value PMON output from the accumulated value holding unit 3 between the accumulated value holding unit 3 and the control unit 5 and outputs the corrected monitor value PMON to the control unit 5.

For example, in a case where a reference power supply voltage V0 is changed to the power supply voltage V due to the DVFS control, the accumulated value holding unit 3 or the correction unit corrects the monitor value PMON by multiplying the monitor value PMON by (V/V0)2. At this time, in order to reduce an error in processing time T2 illustrated in FIG. 2B, the set specification of the clock frequency and the power supply voltage to be switched due to the DVFS control is commonly set in the plurality of arithmetic processing devices 100. Moreover, in a case where the reference power supply voltage V0 is changed according to a variation in electrical characteristic of the arithmetic processing devices 100, it is possible to suppress occurrence of a difference in processing time T2 illustrated in FIG. 2B by creating the set specification between the clock frequency and the power supply voltage such that the values V/V0 become equal to each other.

The monitor value PMON to be output to the control unit 5 by the accumulated value holding unit 3 does not include the value of static power (leakage power value) to be consumed by the arithmetic processing devices 100. In other words, the arithmetic processing devices 100 do not have a circuit that calculates static power according to the variation in electrical characteristic, the power supply voltage, and the chip temperature and a circuit that adds the calculated static power to the monitor value PMON. Therefore, the circuit scale of the processor 100 can be reduced compared to a case where power capping is performed using power values including static power values.

The control device 200 includes a coefficient value holding unit 7 that holds the coefficient value FACT to be transferred to each arithmetic processing device 100 and a power upper limit holding unit 8 that holds the power upper limit PLIMIT of each arithmetic processing device 100 to be transferred to each arithmetic processing device 100. Each unit included in the control device 200 may be formed as a hardware circuit or circuitry. The coefficient value FACT and the power upper limit PLIMIT are respectively stored in the coefficient value holding unit 7 and the power upper limit holding unit 8 before the information processing apparatus IPE1 is activated. The coefficient value FACT and the power upper limit PLIMIT respectively stored in the coefficient value holding unit 7 and the power upper limit holding unit 8 are transferred to each arithmetic processing device 100 from the control device 200 at the time of activation (at the time of power-on and reset release) of the information processing apparatus IPE1. The power upper limit PLIMIT may be calculated in the external portion of the control device 200 and then transferred to the control device 200 or may be calculated by the control device 200 based on the system power upper limit or the like which is the maximum power value to be accepted by the information processing apparatus IPE1.

FIGS. 2A to 2C illustrate an example of the operation of the arithmetic processing devices 100 (1), 100 (2), and 100 (3) illustrated in FIG. 1. FIGS. 2A to 2C illustrate an example in which the arithmetic processing devices 100 (1), 100 (2), and 100 (3) execute data processing in parallel based on the job to be input after being distributed from the control device 200. In the example illustrated in FIGS. 2A to 2C, it is assumed that the static power of the arithmetic processing device 100 (1) is smaller than that of the standard arithmetic processing device, the static power consumed by the arithmetic processing device 100 (2) is the same as that of the standard arithmetic processing device, and the static power of the arithmetic processing device 100 (3) is larger than that of the standard arithmetic processing device. For example, the static power becomes larger when the threshold voltage (electrical characteristic) of transistors to be mounted on the arithmetic processing devices 100 is small. Hereinafter, the variation in electrical characteristic such as the threshold voltage or the like of a transistor resulting from a manufacturing process of manufacturing the arithmetic processing devices 100 is also referred to as process variation.

FIG. 2A illustrates transition of power consumption of each of the arithmetic processing devices 100 (1), 100 (2), and 100 (3) in a case where power capping is not performed. In the case where power capping is not performed, since the arithmetic processing devices 100 (1), 100 (2), and 100 (3) are operated using the same frequency without changing the clock frequency, a processing time T1 of each arithmetic processing device taken for executing certain arithmetic processing is the same as each other.

FIG. 2B illustrates transition of virtual power consumption of each of the arithmetic processing devices 100 (1), 100 (2) and 100 (3) in a case where power capping is performed. Here, the virtual power consumption is represented by the sum of dynamic power indicated by the monitor value PMON output by the accumulated value holding unit 3 illustrated in FIG. 1 and static power consumed by the standard arithmetic processing device. The monitor values PMON output by each accumulated value holding unit 3 of the arithmetic processing devices 100 (1), 100 (2), and 100 (3) indicate dynamic power consumed by the standard arithmetic processing device for a predetermined period. Accordingly, the monitor values PMON are approximately the same as each other regardless of the actual electrical characteristics of the arithmetic processing devices 100 (1), 100 (2), and 100 (3).

In the case where power capping is performed, the control unit 5 of the arithmetic processing devices 100 (1), 100 (2), and 100 (3) lowers the clock frequency in a case where the monitor value PMON (dynamic power value) exceeds the power upper limit value PLIMIT. In the case where the clock frequency is lowered, since the period of the clock cycle becomes longer, a processing time T2 of each of the arithmetic processing device 100 (1), 100 (2), and 100 (3) taken for executing certain arithmetic processing is longer than the processing time T1 illustrated in FIG. 2A. However, the control unit 5 of the arithmetic processing devices 100 (1), 100 (2), and 100 (3) performs power capping using the monitor value PMON generated based on the common coefficient value FACT which does not depend on the process variation. Therefore, the processing time T2 becomes longer than the processing time T1 in the case where power capping is not performed, but the processing time T2 of each arithmetic processing device becomes approximately the same as each other without depending on the process variation of the arithmetic processing devices 100 (1), 100 (2), and 100 (3).

FIG. 2C illustrates transition of actual power consumption of the arithmetic processing devices 100 (1), 100 (2), and 100 (3) in the case where power capping is performed. The actual static power of the arithmetic processing devices 100 (1), 100 (2), and 100 (3) varies due to the dependence on the process variation.

In the arithmetic processing device 100 (1) having static power smaller than that of the standard arithmetic processing device, power capping is performed with a power value smaller than the power value to be power capped in the arithmetic processing device 100 (2) having the same electrical characteristic as the electrical characteristic of the standard arithmetic processing device. Meanwhile, in the arithmetic processing device 100 (3) having dynamic power larger than that of the standard arithmetic processing device, power capping is performed with a power value larger than the power value to be power capped in the arithmetic processing device 100 (2).

In this manner, the information processing apparatus IPE1 illustrated in FIG. 1 calculates the monitor value PMON indicating power to be consumed along with occurrence of an event and performs power capping based on the calculated monitor value PMON. The power to be consumed along with the occurrence of an event is dynamic power which does not include static power, and the dynamic power does not fluctuates much due to a change in power supply voltage and a change in chip temperature compared to the static voltage. In this manner, a change in clock frequency along with the power capping can be made the same in the arithmetic processing devices 100 (1), 100 (2), and 100 (3). Therefore, the processing time taken for processing such as the job can be made equal in the arithmetic processing devices 100 (1), 100 (2), and 100 (3).

Consequently, compared to a case where power capping is performed using the power upper limit based on the actual process variation of the arithmetic processing devices 100 (1), 100 (2), and 100 (3), it is possible to reduce the waiting time for barrier synchronization for executing parallel processing in a synchronized manner. As a result, even in a case where the clock frequency is controlled by power capping, it is possible to suppress degradation of processing performance of the information processing apparatus IPE1.

Further, the accumulated value holding unit 3 calculates the monitor value PMON indicating dynamic power using the common coefficient value FACT which does not depend on the process variation of the arithmetic processing devices 100 (1), 100 (2), and 100 (3). In this manner, the monitor values PMON output by each accumulated value holding unit 3 can be made the same as each other in the arithmetic processing devices 100 (1), 100 (2), and 100 (3) having electrical characteristics different from each other. In addition, the power capping can be performed by regarding the arithmetic processing devices 100 (1), 100 (2), and 100 (3) as the standard arithmetic processing device by setting the coefficient value FACT as indicated by the monitor value PMON of the dynamic power consumed by the standard arithmetic processing device. In this manner, the average value of dynamic power actually consumed by the arithmetic processing devices 100 (1), 100 (2), and 100 (3) can be made approximately the same as the value of dynamic power consumed by the standard arithmetic processing device. As a result, it is possible to inhibit the total value of power consumed by the arithmetic processing devices 100 (1), 100 (2), and 100 (3) from exceeding the upper limit of power accepted by the information processing apparatus IPE1. That is, even in a case where power capping is performed without using power to be actually consumed, it is possible to inhibit the total value of power from exceeding the upper limit of power accepted by the information processing apparatus IPE1.

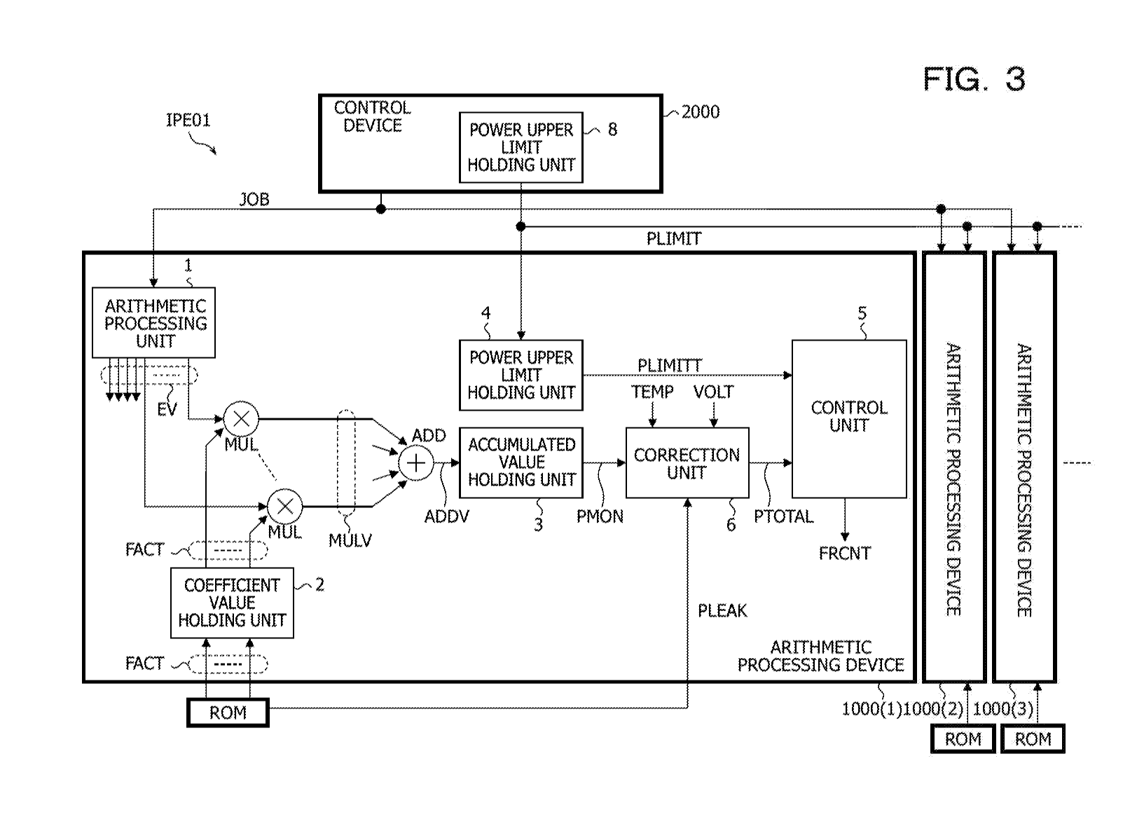

FIG. 3 illustrates another example of an information processing apparatus. The description of the same or similar elements as the elements of FIG. 1 will not be repeated. Since arithmetic processing devices 1000 (1), 1000 (2), and 1000 (3) have the same or similar configuration, the arithmetic processing device 1000 (1) will be described below.

An information processing apparatus IPE01 illustrated in FIG. 3 includes a plurality of arithmetic processing devices 1000 (1000 (1), 1000 (2), and 1000 (3)) and a control device 2000 that controls the operation of the arithmetic processing devices 1000. The arithmetic processing device 1000 (1) includes a correction unit 6 in addition to the arithmetic processing unit 1, the coefficient value holding unit 2, the accumulated value holding unit 3, the power upper limit holding unit 4, and the control unit 5 similar to the arithmetic processing devices 100 illustrated in FIG. 1. Each unit such as the correction unit 6 may be formed as a hardware circuit or circuitry.

The coefficient value holding unit 2 holds the coefficient value FACT output not from the control device 2000 but from a read only memory (ROM) provided for each arithmetic processing device 1000. The coefficient value FACT held by the coefficient value holding unit 2 is different for each arithmetic processing device 1000 and set according to the process variation of each arithmetic processing device 1000. For this reason, the added value ADDV output from the adder ADD indicates an estimated value of actual power (dynamic power which does not include static power such as leakage power) consumed by each arithmetic processing device 1000 for each clock cycle.

The correction unit 6 corrects the monitor value PMON (dynamic power value) output from the accumulated value holding unit 3 based on a power supply voltage value VOLT supplied to the arithmetic processing device 1000 (1). Further, the correction unit 6 corrects a static power value PLEAK output from the ROM based on the power supply voltage value VOLT and a temperature TEMP of the arithmetic processing devices 1000 (1). The static power value PLEAK is set for each arithmetic processing device 1000 based on the electrical characteristics of the arithmetic processing devices 1000. In addition, a power value PTOTAL obtained by adding the corrected static power value PLEAK to the corrected monitor value PMON is output to the control unit 5. The control unit 5 performs power capping by generating the frequency control signal FRCNT that controls the frequency of the arithmetic processing device 1000 (1) such that a power value PTOTAL generated for each predetermined period does not exceed a power upper limit PLIMITT.

The control device 2000 does not include the coefficient value holding unit 7 illustrated in FIG. 1 but includes the power upper limit holding unit 8. The power upper limit PLIMITT held by the power upper limit holding unit 4 is the maximum value of consumed power (dynamic power+static power) which can be equally allocated to each arithmetic processing device 1000 by the information processing apparatus IPE01 and is different from the power upper limit PLIMIT of dynamic power illustrated in FIG. 1.

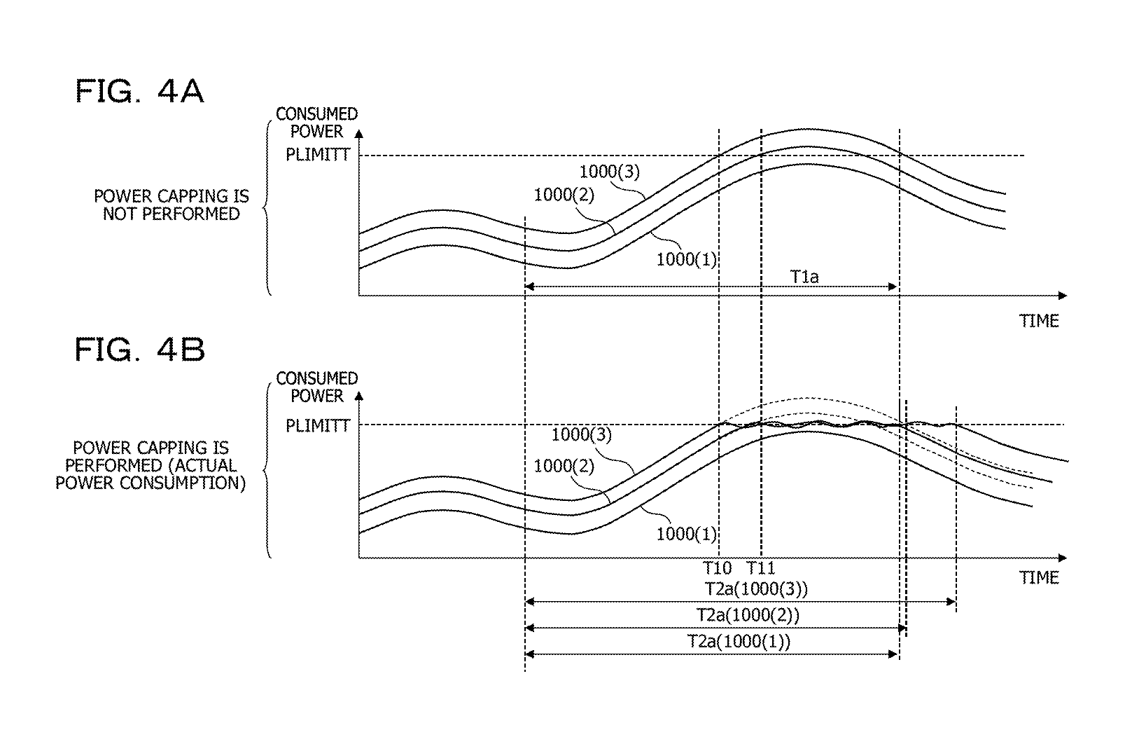

FIGS. 4A and 4B illustrate an example of the operation of the arithmetic processing devices 1000 illustrated in FIG. 3. The description of the same operation as in FIG. 1 will not be repeated. The electrical characteristics of the respective arithmetic processing devices 1000 (1), 1000 (2), and 1000 (3) are the same as the electrical characteristics of the respective arithmetic processing devices 100 (1), 100 (2), and 100 (3) illustrated in FIG. 1. That is, the consumed power is in an ascending order of the arithmetic processing devices 1000 (1), 1000 (2), and 1000 (3).

FIG. 4A illustrates transition of power consumption of each of the arithmetic processing devices 1000 (1), 1000 (2), and 1000 (3) in a case where power capping is not performed and FIG. 4A illustrates the same tendency as in FIG. 2A. In the case where power capping is not performed, the clock frequencies of the arithmetic processing devices 1000 (1), 1000 (2), and 1000 (3) are the same as each other. Therefore, a processing time T1a of each of the arithmetic processing devices 1000 (1), 1000 (2), and 1000 (3) taken for executing certain arithmetic processing is the same as each other.

FIG. 4B illustrates transition of power consumption of each of the arithmetic processing devices 1000 (1), 1000 (2) and 1000 (3) in a case where power capping is performed. The transition of power consumption illustrated in FIG. 4B is indicated by the power value PTOTAL output by the correction unit 6 illustrated in FIG. 3 and is approximately the same as the value of power actually consumed by each of the arithmetic processing devices 1000 (1), 1000 (2), and 1000 (3).

In a case where power capping is performed, the control unit 5 of the arithmetic processing devices 1000 (1), 1000 (2), and 1000 (3) lowers the clock frequency in a case where the power value PTOTAL exceeds the power upper limit value PLIMITT. In the example illustrated in FIG. 4A, the power value PTOTAL of the arithmetic processing device 1000 (3) exceeds the power upper limit PLIMITT at a time T10 and the power value PTOTAL of the arithmetic processing device 1000 (2) exceeds the power upper limit PLIMITT at a time T11. The power value PTOTAL of the arithmetic processing device 1000 (1) does not exceed the power upper limit PLIMITT.

As the time at which the power value PTOTAL exceeds the power upper limit PLIMITT is earlier, the time for executing the arithmetic processing by lowering the clock frequency becomes longer. As a result, a processing time T2a (1000 (3)) of the arithmetic processing device 1000 (3) taken for executing certain arithmetic processing is the longest compared to a processing time T1a illustrated in FIG. 4A. The processing time T2a (1000 (2)) of the arithmetic processing device 1000 (2) taken for executing certain arithmetic processing is shorter than the processing time T2a (1000 (3)) and longer than to a processing time T1a. The processing time T2a (1000 (1)) of the arithmetic processing device 1000 (1) at which the power value PTOTAL does not exceed the power upper limit PLIMITT is the same as the processing time T1a.

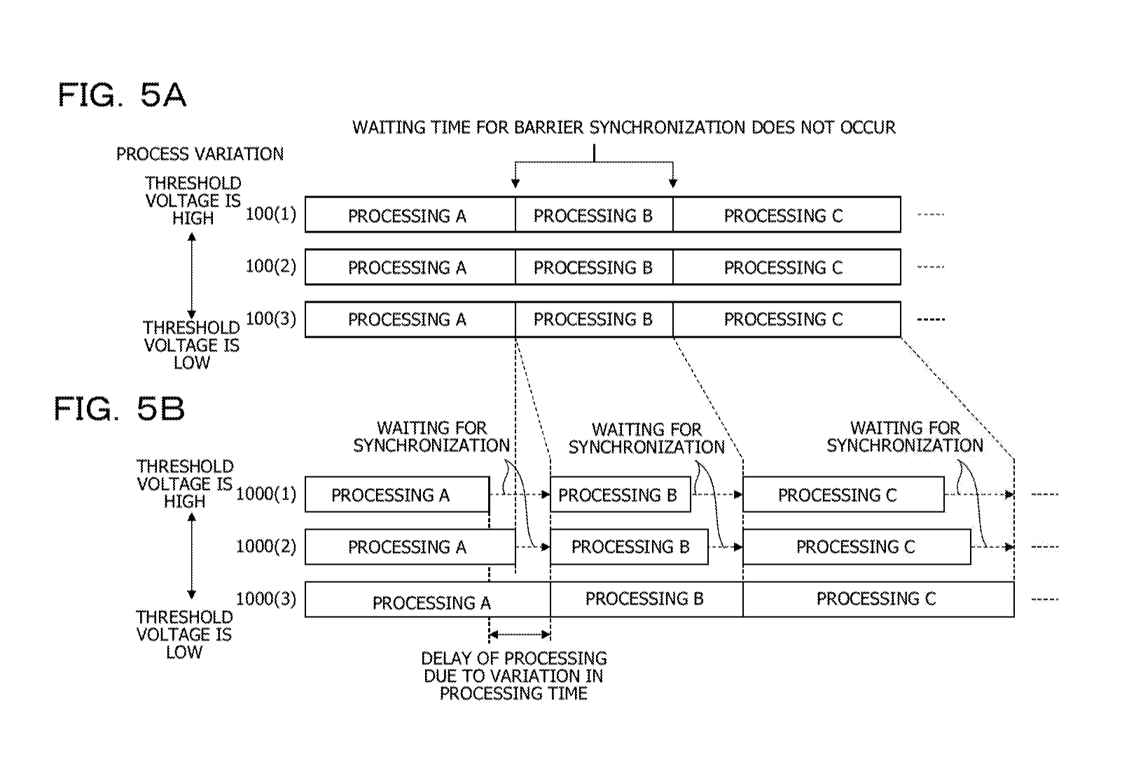

Accordingly, in a case where power capping is performed based on power actually consumed by the arithmetic processing devices 1000, the processing time T2a varies according to the process variation of the arithmetic processing devices 1000. As a result, as illustrated in FIG. 5B, synchronization waiting occurs in the synchronous processing and the processing performance of the information processing apparatus is degraded.

FIGS. 5A and 5B are diagrams illustrating an example of synchronous processing executed by the information processing apparatus IPE1 illustrated in FIG. 1 and the information processing apparatus illustrated IPE01 in FIG. 3. FIG. 5A illustrates an example of synchronous processing executed by the information processing apparatus IPE1 illustrated in FIG. 1. FIG. 5B illustrates an example of synchronous processing executed by the information processing apparatus IPE01 illustrated in FIG. 3. The information processing apparatuses IPE1 and IPE01 both perform power capping.

The control device 200 illustrated in FIG. 1 allows the arithmetic processing devices 100 (1), 100 (2), and 100 (3) to execute processing A, processing B, and processing C in parallel in this order. The control device 200 performs synchronous processing of waiting for completion of all processing A, B, and C of the arithmetic processing devices 100 (1), 100 (2), and 100 (3) without starting the next process. Similarly, the control device 2000 illustrated in FIG. 3 allows the arithmetic processing devices 1000 (1), 1000 (2), and 1000 (3) to execute processing A, processing B, and processing C in parallel in this order. The control device 2000 performs synchronous processing of waiting for completion of all processing A, B, and C of the arithmetic processing devices 1000 (1), 1000 (2), and 1000 (3) without starting the next process.

In FIG. 5A, the processing time taken for the arithmetic processing devices 100 (1) and 100 (3) to execute processing (for example, the processing A) is the same as the processing time taken for the arithmetic processing device 100 (2), having the same process variation as that of the standard arithmetic processing device, to execute processing (for example, processing A). Accordingly, it is possible to start the next processing (for example, processing B) without causing the waiting time for barrier synchronization. As a result, even in a case where the clock frequency is controlled by power capping, the processing times of each of the processing A, B, and C can be aligned in the arithmetic processing devices 100 (1), 100 (2), and 100 (3), and it is possible to suppress occurrence of the waiting time (synchronization waiting) of barrier synchronization. Therefore, it is possible to suppress degradation of processing performance of the information processing apparatus IPE1.

In FIG. 5B, the processing time for each of the processing A, B, and C is different for each of the arithmetic processing devices 1000 (1), 1000 (2), and 1000 (3) according to the power consumed depending on the process variation. In the arithmetic processing device 1000 (1) in which the threshold voltage is high and power consumption is relatively small, since a decrease in the clock frequency due to power capping does not occur, the processing is completed at the earliest. Meanwhile, in the arithmetic processing device 1000 (3) in which the threshold voltage is low and power consumption is relatively large, since a decrease in the clock frequency due to power capping occurs, the processing is completed late. For this reason, the synchronization waiting occurs and the processing performance of the information processing apparatus IPE01 is degraded.

Hereinbefore, according to the embodiment illustrated in FIGS. 1 to 5, the plurality of arithmetic processing devices 100 executing the same processing generate the monitor values PMON which are equal to each other regardless of the process variation. For example, the monitor values PMON which are equal to each other can be generated using the common coefficient value FACT. Further, each arithmetic processing device 100 performs power capping by comparing the monitor values PMON which are equal to each other with the power upper limit PLIMIT which is the upper limit of dynamic power. In this manner, the processing times of arithmetic processing executed by the arithmetic processing devices 100 can be made equal to each other regardless of the process variation and occurrence of the waiting time for barrier synchronization for executing parallel processing in a synchronized manner can be reduced. As a result, in a case where the clock frequency is controlled by power capping, it is possible to suppress power consumption and degradation of processing performance.

Further, since each arithmetic processing device 100 generates the monitor value PMON equal to the value of dynamic power consumed by the standard arithmetic processing device having an average electrical characteristic, the power capping can be performed by regarding each arithmetic processing device 100 as the standard arithmetic processing device. In this manner, the average value of dynamic power actually consumed by the plurality of arithmetic processing devices 100 can be generated as the monitor value PMON. Therefore, it is possible to inhibit the total value of power consumed by the plurality of arithmetic processing devices 100 from exceeding the upper limit of power accepted by the information processing apparatus IPE1. That is, even in a case where power capping is performed without using power to be actually consumed, it is possible to inhibit the total value of power consumed by the plurality of arithmetic processing devices 100 from exceeding the upper limit of power accepted by the information processing apparatus IPE1 and to suppress degradation of reliability of the information processing apparatus IPE1.

Moreover, the circuit scale of the arithmetic processing devices 100 can be reduced compared to a case where power capping is performed using power values including static power values.

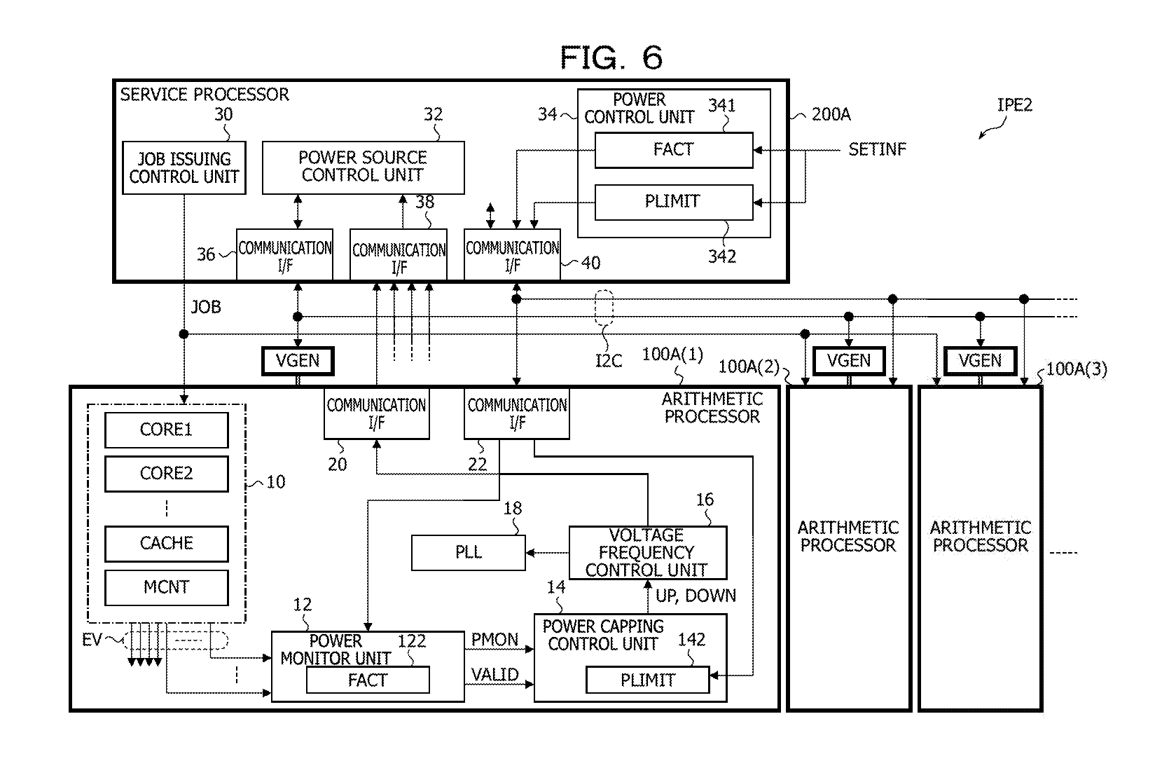

FIG. 6 is a diagram illustrating another embodiment of an information processing apparatus, an arithmetic processing device, and a method of controlling an information processing apparatus. The same or similar elements as the elements illustrated in FIG. 1 are denoted by the same reference numerals and the detailed description thereof will not be repeated.

An information processing apparatus IPE2 illustrated in FIG. 6 includes a plurality of arithmetic processors 100A (100A (1), 100A (2), and 100A (3)) and a service processor 200A that controls the operation of the arithmetic processors 100A. Each arithmetic processor 100A is an example of the arithmetic processing device and the service processor 200A is an example of a control device. Hereinafter, the arithmetic processors 100A (100A (1), 100A (2), and 100A (3)) are also simply referred to as processors 100A (100A (1), 100A (2), and 100A (3)).

For example, the information processing apparatus IPE2 is used in the field of HPC similar to the information processing apparatus IPE1 illustrated in FIG. 1 and functions as a parallel computer. Since the processors 100A (1), 100A (2), and 100A (3) have the same or similar configuration, the processor 100A (1) will be described below.

The processor 100A (1) includes a functional block unit 10, a power monitor unit 12, a power capping control unit 14, a voltage frequency control unit 16, a PLL 18, and communication interfaces (I/F) 20 and 22. Each unit included in the processor 100A may be formed as a hardware circuit or circuitry.

The functional block unit 10 includes functional blocks such as a plurality of processor cores CORE (CORE1, CORE2, and the like) that realize the function of the arithmetic processing device 100A (1), a cache memory CACHE, and a memory access controller MCNT. The processor core CORE executes arithmetic processing based on the job JOB issued by the service processor 200A. The cache memory CACHE includes a cache memory unit that holds data read from the main memory (not illustrated) connected to the arithmetic processing device 100A and a cache control unit that controls data held by the cache memory unit. The memory access controller MCNT controls access of the main memory based on a memory access request output from the processor core CORE. The cache memory CACHE is an example of a cache memory unit and the memory access controller MCNT is an example of a memory access control unit. Each unit included in the cache memory may be formed as a hardware circuit or circuitry.

Each of the processor core CORE, the cache memory CACHE, and the memory access controller MCNT outputs an event signal EV indicating occurrence of events such as processing and operation internally executed. The functional block unit 10 outputs an event signal EV, among the event signals EV, indicating occurrence of a target event which is an event having a deep relationship with power consumption to the power monitor unit 12.

The power monitor unit 12 includes a plurality of registers 122 holding a plurality of coefficient values FACT to be transferred from the service processor 200A. A register 122 is an example of the coefficient value holding unit. The plurality of coefficient values FACT correspond to the event signals EV (target events) received by the power monitor unit 12 and are used to calculate power to be consumed due to execution of a target event.

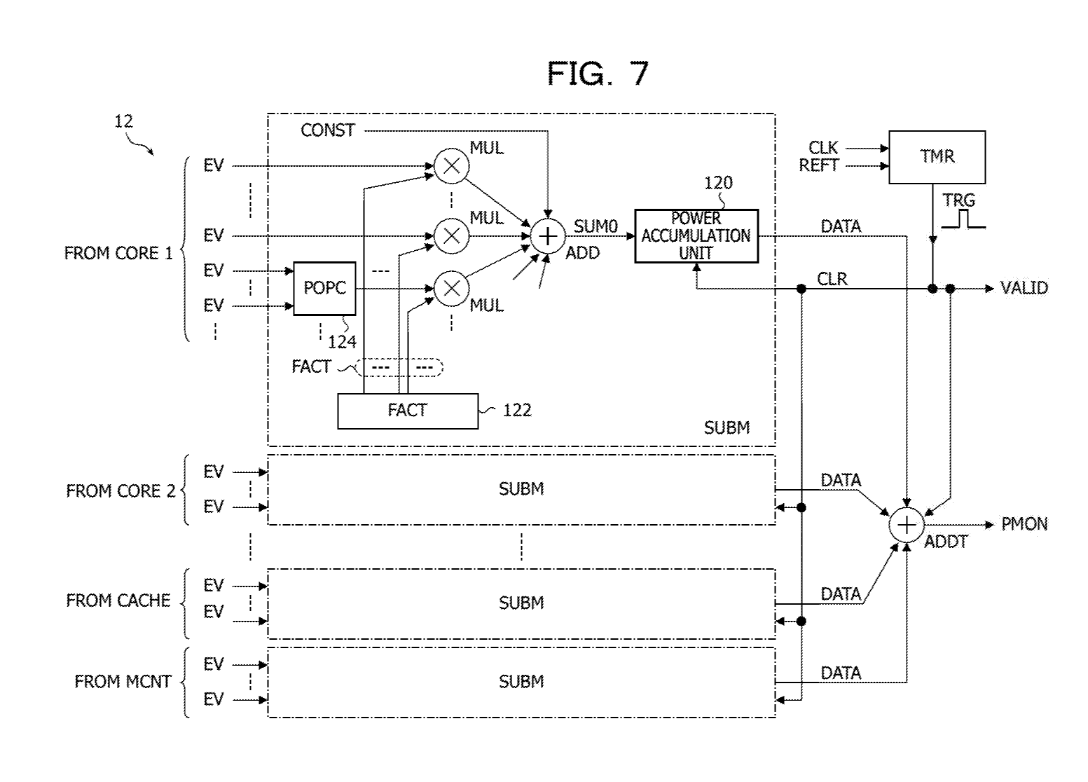

The power monitor unit 12 generates the monitor values PMON of dynamic power to be consumed by the processor 100A (1) for a predetermined period based on the event signals EV receive by the functional block unit 10 and the coefficient values FACT held by the register 122. In addition, the power monitor unit 12 outputs the generated monitor values PMON to the power capping control unit 14 together with a valid signal VALID. The example of the power monitor unit 12 is illustrated in FIG. 7. Further, the monitor values PMON is not a value of dynamic power to be actually consumed by the processor 100A (1) but a value of dynamic power (estimated value) to be consumed by the processors 100A having an average electrical characteristic. Hereinafter, the processors 100A having the average electrical characteristic is also referred to as a standard processor. In addition, in a case where the DVFS control is performed, similar to the description in FIG. 1, it is preferable that the power monitor unit 12 corrects the monitor value PMON by multiplying the monitor value PMON by (V/V0)2 according to the fluctuation of the power supply voltage. Further, the processor 100A (1) may include a correction unit, between the power monitor unit 12 and the power capping control unit 14, which corrects the monitor value PMON to be output from the power monitor unit 12 and outputs the corrected monitor value PMON to the power capping control unit 14. Each unit such as the correction unit may be formed as a hardware circuit or circuitry.

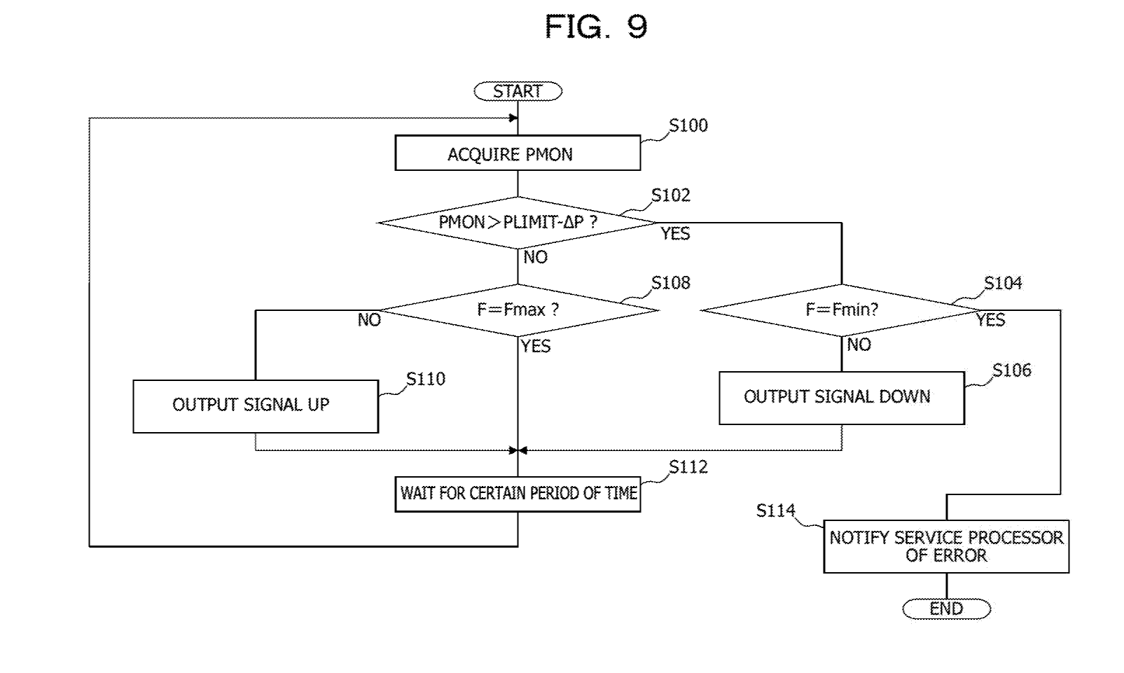

The power capping control unit 14 includes a register 142 that holds the power upper limit PLIMIT to be transferred from the service processor 200A. The power upper limit PLIMIT is calculated by dividing a value, obtained by subtracting the value of static power (leakage power value) to be consumed by the information processing apparatus IPE2 from the system power upper limit which is the maximum value of power which can be consumed by the information processing apparatus IPE2, by the number of arithmetic processing devices 100A in advance. The power capping control unit 14 receives the dynamic power value represented by the monitor value PMON output from the power monitor unit 12 in synchronization with the valid signal VALID. Further, the power capping control unit 14 outputs a down signal DOWN for lowering the clock frequency to the voltage frequency control unit 16 in a case where the monitor value PMON exceeds the power upper limit PLIMIT held by the register 142. Moreover, the power capping control unit 14 outputs an up signal UP to the voltage frequency control unit 16 in a case where the clock frequency is increased. An example of the operation of the power capping control unit 14 is illustrated in FIG. 9.

The voltage frequency control unit 16 executes DVFS control that changes the clock frequency and the power supply voltage to be supplied to the processor 100A (1) based on the state of the operation of the processor 100A (1). In the DVFS control, the voltage frequency control unit 16 increases the clock frequency after increasing the power supply voltage and decreases the power supply voltage after decreasing the clock frequency. In a case where the power supply voltage is changed, the voltage frequency control unit 16 outputs an instruction of changing the power supply voltage to the service processor 200A via the communication I/F 20. The voltage frequency control unit 16 outputs a control signal for increasing the clock frequency when the up signal UP is received to the PLL and outputs the control signal for decreasing the clock frequency when the down signal DOWN is received to the PLL. Further, the processor 101A includes a frequency control unit in place of the voltage frequency control unit 16 and may perform the DFS control. Each unit such as the frequency control unit may be formed as a hardware circuit or circuitry.

The communication I/F 20 is connected to a communication I/F 38 of the service processor 200A via a communication line and transmits an instruction of changing the power supply voltage to the service processor 200A. The communication I/F 22 is connected to a communication I/F 40 of the service processor 200A and other processors 100A (2) and 100A (3) via an I2C bus or the like. The communication I/F 22 of each processor 100A outputs the coefficient value FACT received from the service processor 200A to the power monitor unit 12 for storing the coefficient value FACT in the register 122. In addition, the communication I/F 22 of each processor 100A outputs the power upper limit PLIMIT received from the service processor 200A to the power capping control unit 14 for storing the upper limit value PLIMIT in the register 142.

The service processor 200A includes a job issuing control unit 30, a power supply control unit 32, a power control unit 34, and communication I/Fs 36, 38, and 40. The power control unit 34 includes a register 341 that holds the coefficient value FACT and a register 342 that holds the power upper limit PLIMIT. The coefficient value FACT and the power upper limit PLIMIT are supplied to the service processor 200A as setting information SETINF at the time of activation of the information processing apparatus IPE2 and respectively stored in the registers 341 and 342. The coefficient value FACT stored in the register 341 and the upper limit PLIMIT stored in the register 342 are transferred to each processor 100A via the communication I/F 40 and commonly used for the plurality of processors 100A. Each unit included in the service processor 200A may be formed as a hardware circuit or circuitry.

The job issuing control unit 30 distributes the job JOB (data) to each processor 100A and allows each processor 100A to execute the job JOB in parallel. The power supply control unit 32 receives an instruction of changing the power supply voltage from each processor 100A via the communication I/F 38 and outputs an instruction of changing the power supply voltage to a voltage generator VGEN corresponding to the processor 100A in which the instruction is received via the communication I/F 36. For example, the communication I/F 38 is connected to the voltage generator VGEN via the I2C bus. The voltage generator VGEN provided in correspondence with each processor 100A is a direct current (DC)/DC converter, generates the power supply voltage instructed by the power supply control unit 32, and supplies the generated power supply voltage to the corresponding processor 100A.

Hereinafter, a method of calculating the coefficient value FACT will be described.

As represented by Equation (1), it is preferable that the monitor value PMON of dynamic power becomes the average of dynamic power values of all the processors 100 mounted on the information processing apparatus IPE1. In Equation (1), the symbol P[i] indicates an actual dynamic power value of the i-th processor 100 among N processors 100 mounted on the information processing apparatus IPE1 and the symbol N indicates the number of processors 100 mounted on the information processing apparatus IPE1. The actual dynamic power value of the processors 100 varies due to the process variation resulting from fluctuation of the condition for manufacturing a processor.

PMON=ΣiP[i]/N (1)

Next, two methods of calculating the coefficient value FACT for using the monitor value PMON as the average of dynamic power values of all the processors 100 mounted on the information processing apparatus IPE1.

Method 1 of calculating coefficient value FACT: calculation from probability distribution of variation in dynamic power

In some cases, the number of processors 100 mounted on the information processing apparatus IPE1 is sufficiently large so that the error is small enough to be negligible even when the variation in dynamic power is statistically dealt with. In this case, the coefficient value FACT which generates an average value of dynamic power can be calculated from the probability distribution characteristic (probability density function) of a variation in power acquired from device models of circuit simulators or a large amount of samples.

First, an average value P′ dynamic power of the processors 100 mounted on the information processing apparatus IPE1 is represented by Equation (2). In Equation (2), the symbol V0 indicates a power supply voltage V0 and the symbol Pr(D) indicates a probability density function (probability density of a processor in which an element normalized at a power supply voltage V0 has a delay amount D) with respect to a variation of the delay amount D of the element mounted in the processors 100. The symbol P(D) indicates dynamic power of the processors 100 at a power supply voltage V0 and the symbol V(D) indicates a power supply voltage applied to the processors 100 in a case where the power supply voltage is adjusted according to the variation in the delay amount D. The symbol D_min indicates the minimum value of the delay amount D which can be acquired by an element in the processors 100 having passed an operation test. The symbol D_max indicates the maximum value of the delay amount D which can be acquired by an element in the processors 100 having passed an operation test. Here, the temperature dependence of the dynamic power value is small enough to be negligible and it is assumed that the dynamic power value is proportional to the square of the power supply voltage.

In Equation (2), “(V(D)/V0)2” is a correction term of dynamic power in a case where the power supply voltage is “V(D)” and the denominator in Equation (2) is a correction term of a probability density function Pr(D) resulting from narrowing the delay amount D of the element.

$${P}^{′} = \frac{{\int }_{D\_min}^{D\_max} P ( D ) \cdot Pr ( D ) \cdot {( \frac{V ( D )}{V 0} )}^{2} d D}{{\int }_{D\_min}^{D\_max} Pr ( D ) \cdot d ( D )} \qquad ( 2 )$$

In a case where the coefficient value FACT is acquired before the processors 100 are manufactured (design period or the like), a power consumption library having a power variation corresponding to the average value P′ of dynamic power is generated. In addition, the coefficient values are tuned using the result of power analysis performed using the generated power consumption library and the coefficient values obtained by the tuning are used as the common coefficient values FACT.

In a case where the coefficient values FACT are acquired after the processors 100 are manufactured (after designing), the coefficient values using the electrical characteristics of the processors 100 having a power variation corresponding to the average value P′ of dynamic power are tuned. Further, the coefficient values obtained by the tuning are used as the common coefficient values FACT.

Method 2 of calculating coefficient value FACT: calculation from coefficient values to which power variation of each processor 100 is reflected

The calculation method 2 is a method of acquiring the coefficient value FACT based on information related to the power variation of the processors 100 mounted on the information processing apparatus IPE1. For example, in a case where the number of the processors 100 mounted on the information processing apparatus IPE1 is smaller than a predetermined number and the error becomes larger in statistical processing, the coefficient values FACT are acquired using the calculation method 2.

First, in all processors 100 mounted on the information processing apparatus IPE1, the coefficient values FACT for generating the monitor value PMON of dynamic power with respect to the dynamic power for each processor 100 are tuned in advance. Equation (3) is established from the properties of the monitor value PMON of dynamic power. In Equation (3), the symbol P[i] indicates the dynamic power value of the i-th processor 100 among N processors 100 mounted on the information processing apparatus IPE1. The symbol C0[i] indicates stationary dynamic power (clock power or the like) of the i-th processor 100. The symbol C[i][j] indicates the coefficient value of the j-th event signal EV in the i-th processor 100. The symbol A[i][j] indicates the number of times of occurrences of the j-th event signal EV in the i-th processor 100.

P[i]=C0[i]+Σj(C[i][j]·A[i][j]) (3)

The monitor value PMON which is the average value of the dynamic power values of all processors 100 mounted on the information processing apparatus IPE1 is represented by Equation (4) obtained by substituting Equation (3) into Equation (1).

$$\begin{matrix}PMON = \sum iP [ i ] / N \\ = \sum i \{ C 0 [ i ] + \sum j ( C [ i ] [ j ] \cdot A [ i ] [ j ] ) / N \\ = \sum i \{ C 0 [ i ] / N + \sum i \sum j ( C [ i ] [ j ] \cdot A [ i ] [ j ] ) / N \\ = \sum i \{ C 0 [ i ] / N + \sum j ( \sum iC [ i ] [ j ] / N ) \cdot A [ i ] [ j ]\end{matrix} \qquad ( 4 )$$

The coefficient value FACT is acquired by averaging the coefficient values C[i][j] of the processors 100 for each event signal EV from “Σj(ΣiC[i][j]/N” in Equation (4).

Next, a method of calculating the power upper limit PLIMIT will be described. The power upper limit PLIMIT is calculated using the system power upper limit and the system static power value as represented by Equation (5).

The power upper limit PLIMIT=(system power upper limit−system static power value)/number of processors−error margin (5)

Hereinafter, two methods of calculating the system static power value will be described.

[Method 1 of calculating system static power value]: In the calculation method 1, a probability distribution of variation in static power is used. In some cases, the number of processors 100 mounted on the information processing apparatus IPE1 is sufficiently large so that the error is small enough to be negligible even when the variation in static power is statistically dealt with. In this case, an average value of static power can be calculated from the probability distribution characteristic (probability density function) of a variation in power acquired from device models of circuit simulators or a large amount of samples.

That is, similar to Equation (2), an average value P″ of static power of the processors 100 mounted on the information processing apparatus IPE1 is represented by Equation (6). In Equation (6), the symbol V0 indicates a power supply voltage V0 and the symbol Pr(D) indicates a probability density function (probability density of a processor in which an element normalized at a power supply voltage V0 has a delay amount D) with respect to a variation of the delay amount D of the element mounted in the processors 100. The symbol P(D) indicates static power of the processors 100 at a power supply voltage V0 and the symbol V(D) indicates a power supply voltage applied to the processors 100 in a case where the power supply voltage is adjusted according to the variation in the delay amount D. The symbol D_min indicates the minimum value of the delay amount D which can be acquired by an element in the processors 100 having passed an operation test. The symbol D_max indicates the maximum value of the delay amount D which can be acquired by an element in the processors 100 having passed an operation test. Here, it is assumed that the chip temperature of the processors 100 is a temperature in the vicinity of the maximum consumed power. In Equation (6), “(V(D)/V0)” is a correction term of static power in a case where the power supply voltage is “V(D)” and the denominator in Equation (6) is a correction term of a probability density function Pr(D) resulting from narrowing the delay amount D of the element. In addition, the system static power value can be calculated by multiplying the average value P″ of static power of the processor 100 calculated using Equation (6) by the number of processors 100.

$${P}^{″} = \frac{{\int }_{D\_min}^{D\_max} P ( D ) \cdot Pr ( D ) \cdot \frac{V ( D )}{V 0} d D}{{\int }_{D\_min}^{D\_max} Pr ( D ) \cdot d ( D )} \qquad ( 6 )$$

[Method 2 of calculating system static power value]: In the calculation method 2, a static power values to which power variation of each processor 100 is reflected is used. The calculation method 2 is a method of calculating the system static power based on information related to the static power of all the processors 100 mounted on the information processing apparatus IPE1. In this method, the static power values are acquired at a predetermined power supply voltage and a predetermined temperature when each processor 100 is tested and the system static power values are calculated by summing values obtained by correcting the acquired static power values at the power supply voltage and the temperature.

FIG. 7 illustrates an example of the power monitor unit 12 illustrated in FIG. 6. The power monitor unit 12 includes processor cores CORE1 and CORE2, a plurality of sub monitors SUBM respectively provided in correspondence with a cache memory CACHE and a memory access controller MCNT, an adder ADDT, and a timer TMR. Since the sub monitors SUBM have the same configuration, a sub monitor SUBM that calculates dynamic power consumed by the processor core CORE1 will be described below.

The sub monitor SUBM includes a register 122 holding the coefficient value FACT, a population counter 124, a plurality of multipliers MUL, an adder ADD, and a power accumulation unit 120, and the dynamic power (estimated value) assumed by each functional block is calculated. Each unit included in the sub monitor may be formed as a hardware circuit or circuitry.

The population counter 124 counts the number of times of receiving a plurality of event signals EV corresponding to the common coefficient value FACT and outputs the counter value obtained by the counting to one multiplier MUL. For example, the event signals EV received by the population counter 124 are generated at the time of execution of an arithmetic operation by a plurality of arithmetic elements (floating point arithmetic elements and the like) having the same configuration as each other. Using the population counter 124, the plurality of event signals EV corresponding to the common coefficient value FACT can be arranged and the number of multipliers MUL can be reduced compared to a case where each event signal EV is supplied to the multipliers MUL.

Each multiplier MUL multiplies the value (“1” or “0”) of the event signal EV or the counter value from the population counter 124 and the coefficient value FACT and outputs the multiplied value obtained by multiplication to the adder ADD. The adder ADD adds the multiplied value output from the multiplier MUL and a constant value CONST and outputs an added value SUMO obtained by the addition to the power accumulation unit 120.

For example, the population counter 124, the multiplier MUL, and the adder ADD are operated for each clock cycle. The added value SUMO output by the adder ADD indicates power (dynamic power which does not include static power such as leakage power) consumed by the processor core CORE1 mounted on the standard processor for each clock cycle and is different from power consumed by the actual processor core CORE1. The constant value CONST indicates a value of power stationarily consumed for each clock cycle even when a functional block is not in an operation but in a standby state, such as clock power that occurs due to generation of a clock.

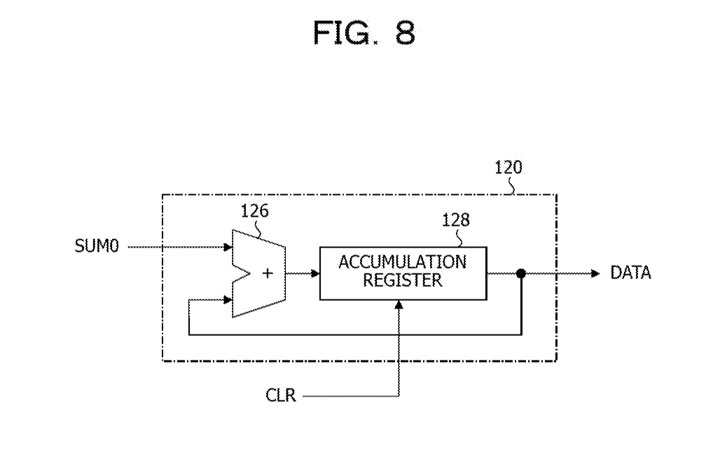

The power accumulation unit 120 accumulates the added value SUMO for a predetermined period, holds the accumulated values, and outputs the accumulated values for a predetermined period to the adder ADDT as accumulated values DATA. The predetermined period indicates an interval in which a trigger signal TRG is output from the timer TMR. The power accumulation unit 120 receives the trigger signal TRG as a clear signal CLR and clears the accumulated values DATA held by being synchronized with the clear signal CLR to “0”. The accumulated value DATA indicates the value of power (average value of dynamic power consumed by the plurality of arithmetic processing devices 100) consumed by the standard arithmetic processing device for a predetermined period and is different from the actual value of power consumed by the arithmetic processing device 100 (1) for a predetermined period. The power accumulation unit 120 provided in correspondence with the processor core CORE1 and CORE2, the cache memory CACHE, and the memory access controller MCNT is an example of the accumulated value holding unit. An example of the power accumulation unit 120 is illustrated in FIG. 8.

The adder ADDT adds the accumulated value DATA output from the sub monitor SUBM in synchronization with the valid signal VALID and calculates the monitor value PMON of dynamic power. The timer TMR starts counting the number of pulses of a clock CLK based on a reference timing signal REFT and outputs the trigger signal TRG whenever the number of pulses for a predetermined period (for example, 2 microseconds) is counted. The clock CLK is different from a clock whose frequency output from the PLL 18 illustrated in FIG. 6 is variable and the frequency thereof is fixed. The trigger signal TRG is output as the clear signal CLR or the valid signal VALID indicating the lapse of a predetermined period. The valid signal VALID is used as a synchronization signal of the adder ADDT or a synchronization signal of the power capping control unit 14 illustrated in FIG. 6.

FIG. 8 illustrates an example of the power accumulation unit 120 illustrated in FIG. 7. The power accumulation unit 120 includes an adder 126 and an accumulation register 128. The adder 126 adds the added value SUMO output from the adder ADD illustrated in FIG. 7 and the accumulated value DATA output from the accumulation register 128 and stores the addition result in the accumulation register 128. The accumulation register 128 repeatedly accumulates the addition result of the adder 126 and holds the accumulated result until being cleared by the clear signal CLR and outputs the held accumulated value DATA. The accumulated value DATA output from the accumulation register 128 in synchronization with the valid signal VALID indicates the average value of dynamic power consumed by each functional block for a predetermined period (for example, 2 microseconds).

FIG. 9 illustrates an example of the operation of the power capping control unit 14 illustrated in FIG. 6. The operation illustrated in FIG. 9 may be realized by hardware or software (power capping control program) executed by any of the processor cores CORE.

First, in Step S100, the power capping control unit 14 acquires the monitor value PMON output from the power monitor unit 12 in synchronization with the valid signal VALID. Next, in Step S102, the power capping control unit 14 compares the monitor value PMON with a value obtained by subtracting an error margin AP from the power upper limit PLIMIT. In a case where the monitor value PMON is greater than the value obtained by subtracting the error margin AP from the power upper limit PLIMIT, the process proceeds to Step S104. In a case where the monitor value PMON is less than or equal to the value obtained by subtracting the error margin AP from the power upper limit PLIMIT, the process proceeds to Step S108.

In Step S104, in a case where the clock frequency F is a lowest frequency Fmin, the power capping control unit 14 advances the process to Step S114. Meanwhile, in a case where the clock frequency F is not the lowest frequency Fmin (higher than Fmin), the power capping control unit 14 advances the process to Step S106 in order to lower the clock frequency F. In Step S106, the power capping control unit 14 outputs the down signal DOWN to the voltage frequency control unit 16, lowers the clock frequency by one stage, and advances the process to Step S112.

In Step S108, in a case where the clock frequency F is a highest frequency Fmax, the power capping control unit 14 advances the process to Step S112. Meanwhile, in a case where the clock frequency F is not the highest frequency Fmax (lower than Fmax), the power capping control unit 14 advances the process to Step S110 in order to increase the clock frequency F. In Step S110, the power capping control unit 14 outputs the up signal UP to the voltage frequency control unit 16, increases the clock frequency by one stage, and advances the process to Step S112.

In Step S112, the power capping control unit 14 waits until the next valid signal VALID is received and advances the process to Step S100 in a case where the next valid signal VALID is received. In Step S114, the power capping control unit 14 outputs an error notification indicating that the clock frequency F may not be lowered any more to the service processor 200A and the process is finished. The error notification is output to the service processor 200A via the communication I/Fs 22 and 40. The service processor 200A having received the error notification executes error processing of forcibly finishing the process being executed by the processor 100A or the like.

The processor 100A is operated in the same manner as in FIG. 2B by the operation of the power capping control unit 14 illustrated in FIG. 9 and the synchronization processing of the information processing apparatus IPE2 is executed in the same manner as in FIG. 5A.

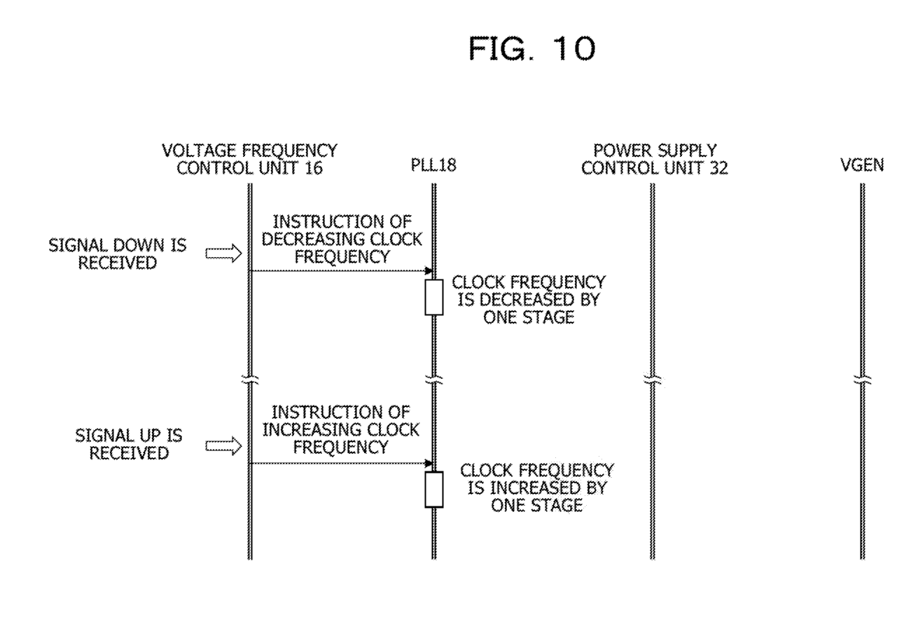

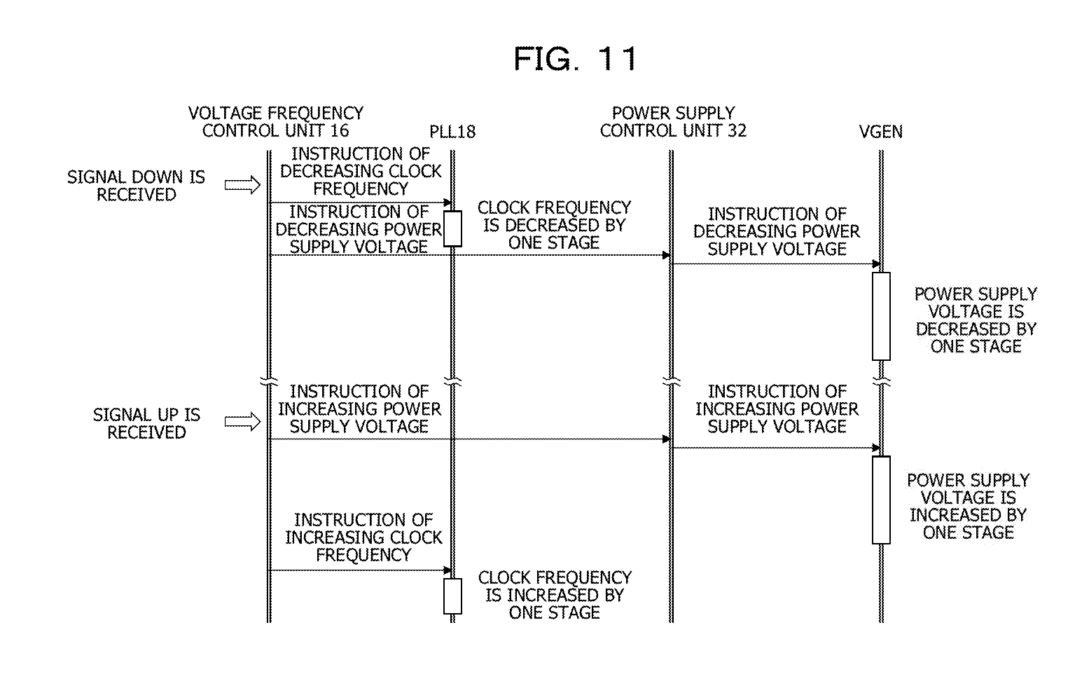

FIG. 10 illustrates an example of the power capping operation controlled by the DFS control of the voltage frequency control unit 16 illustrated in FIG. 6. Further, the voltage frequency control unit 16 may execute the power capping operation controlled by the DVFS control illustrated in FIG. 11.

The voltage frequency control unit 16 outputs an instruction of lowering the clock frequency to the PLL 18 based on the reception of the down signal DOWN. The PLL 18 lowers the clock frequency by one stage based on the instruction from the voltage frequency control unit 16. Further, the voltage frequency control unit 16 outputs an instruction of increasing the clock frequency to the PLL 18 based on the reception of the up signal UP. The PLL 18 increases the clock frequency by one stage based on the instruction from the voltage frequency control unit 16. Further, since the power supply voltage is not changed by the power capping operation controlled by the DFS control, the voltage frequency control unit 16 does not output an instruction of changing the power supply voltage to the power supply control unit 32 even in a case where the up signal UP and the down signal DOWN are received.

FIG. 11 illustrates an example of the power capping operation controlled by the DVFS control of the voltage frequency control unit 16 illustrated in FIG. 6.

The voltage frequency control unit 16 outputs an instruction of lowering the clock frequency to the PLL 18 based on the reception of the down signal DOWN. The PLL 18 lowers the clock frequency by one stage based on the instruction from the voltage frequency control unit 16. After the clock frequency is changed, the voltage frequency control unit 16 outputs an instruction of decreasing the power supply voltage to the power supply control unit 32 of the service processor 200A. Moreover, the completion of a change in clock frequency is determined by the progress of the present number of clock cycles or a signal indicating a PLL lock generated by the PLL 18. The power supply control unit 32 outputs an instruction of decreasing the power supply voltage to a voltage generator VGEN based on the instruction from the voltage frequency control unit 16. The voltage generator VGEN lowers the power supply voltage by one stage based on the instruction from the power supply control unit 32.

Further, the voltage frequency control unit 16 outputs an instruction of increasing the power supply voltage to the power supply control unit 32 of the service processor 200A based on the reception of the up signal UP. The power supply control unit 32 outputs an instruction of increasing the power supply voltage to the voltage generator VGEN based on the instruction from the voltage frequency control unit 16. The voltage generator VGEN increases the power supply voltage by one stage based on the instruction from the power supply control unit 32. After the power supply voltage is changed, the voltage frequency control unit 16 outputs an instruction of increasing the clock frequency to PLL 18. Moreover, the completion of a change in power supply voltage is determined by the lapse of a present time or a notification of completion of a change in power supply voltage which is output from the power supply control unit 32 to the processor 100A. The PLL 18 increases the clock frequency by one stage based on the instruction from the voltage frequency control unit 16.

As illustrated in FIG. 11, in the DVFS control, the voltage frequency control unit 16 decreases the power supply voltage after decreasing the clock frequency and increases the clock frequency after increasing the power supply voltage. In this manner, it is possible to inhibit an increase of the clock frequency by one stage in a state in which the power supply voltage is less than a predetermined value and to inhibit a decrease in an operation margin of the processor 100A.

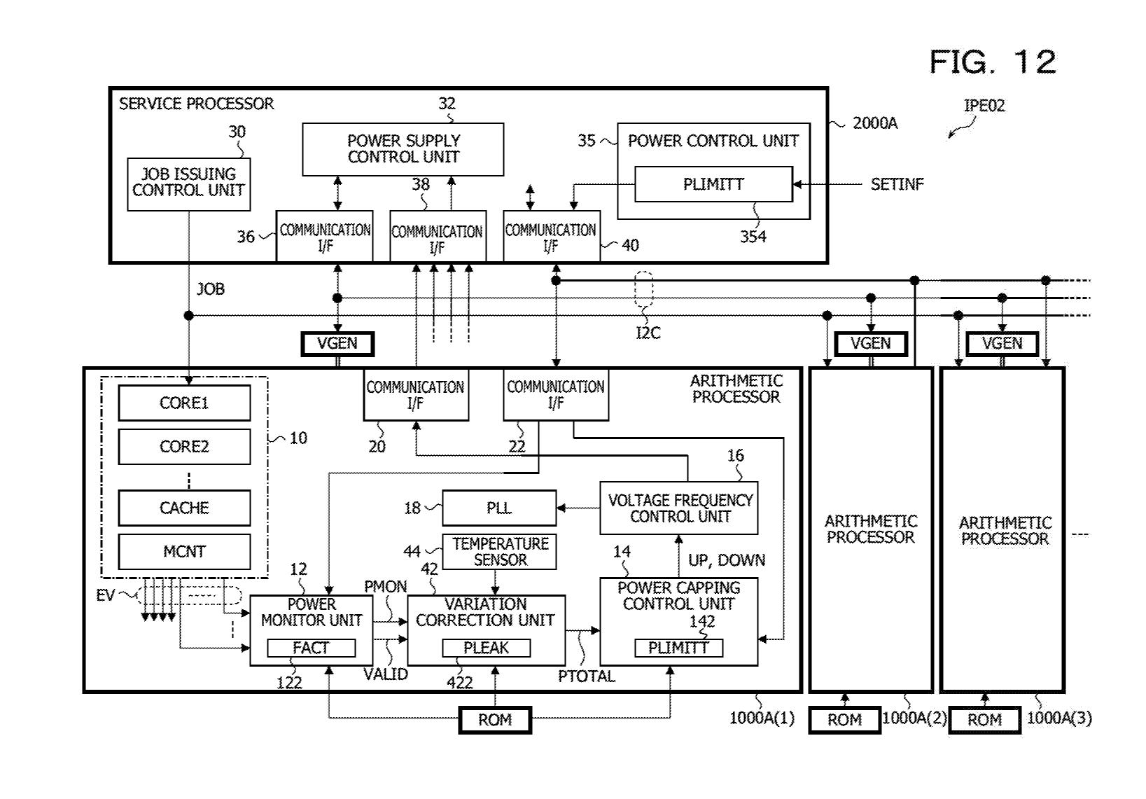

FIG. 12 illustrates another example of an information processing apparatus. The same or similar elements as the elements illustrated in FIG. 6 are denoted by the same reference numerals and the detailed description thereof will not be repeated. An information processing apparatus IPE02 illustrated in FIG. 12 includes a service processor 2000A in place of the service processor 200A illustrated in FIG. 6. Further, the information processing apparatus IPE02 includes a plurality of arithmetic processors 1000A (1000A (1), 1000A (2), and 1000A (3)) in place of the plurality of arithmetic processors 100A (100A (1), 100A (2), and 100A (3)) illustrated in FIG. 6. Hereinafter, the arithmetic processors 1000A (1000A (1), 1000A (2), and 1000A (3)) are also simply referred to as the processors 1000A (1000A (1), 1000A (2), and 1000A (3)). Each of the processors 1000A (1), 1000A (2), and 1000A (3) is connected to the ROM. Other configurations of the information processing apparatus IPE02 are the same as those of the information processing apparatus IPE2 illustrated in FIG. 6.

The service processor 2000A includes a power control unit 35 in place of the power control unit 34 of the service processor 200A illustrated in FIG. 6. The power control unit 35 includes a register 354 holding the power upper limit PLIMITT supplied to the service processor 2000A as setting information SETINF at the time of activation of the information processing apparatus IPE02. The power upper limit PLIMITT is the maximum value of consumed power (dynamic power+static power) equally allocated to each processor 1000A mounted on the information processing apparatus IPE02. Other configurations of the service processor 2000A are the same as those of the service processor 200A illustrated in FIG. 6. Since the processors 1000A (1), 1000A (2), and 1000A (3) have the same or similar configuration, the processor 1000A (1) will be described below. Each unit such as the power control unit 35 may be formed as a hardware circuit or circuitry.

Each processor 1000A (1) has the configuration of the processor 100A illustrated in FIG. 6 and a variation correction unit 42 and a temperature sensor 44 are added thereto. Further, the register 142 of the power capping control unit 14 holds the power upper limit PLIMITT output from the service processor 2000A. The register 122 of the power monitor unit 12 stores the coefficient value FACT output from the ROM connected to the processor 1000A (1). The coefficient value FACT is set for each processor 1000A according to the electrical characteristic of the processor 1000A. Other configurations of each processor 1000A are the same as those of the processor 100A (1) illustrated in FIG. 6. Each unit such as the variation correction unit 42 may be formed as a hardware circuit or circuitry.

The variation correction unit 42 includes a register 422 that holds the static power value PLEAK output from the ROM. Similar to the correction unit 6 illustrated in FIG. 3, the variation correction unit 42 corrects the monitor value PMON (dynamic power value) output from the power monitor unit 12 based on a power supply voltage value supplied to the arithmetic processing device 1000A (1). Further, the variation correction unit 42 corrects the static power value PLEAK output from the ROM based on the power supply voltage value and the temperature TEMP detected by the temperature sensor 44. In addition, the variation correction unit 42 outputs the power value PTOTAL, obtained by adding the corrected static power value PLEAK to the corrected monitor value PMON, to the power capping control unit 14. Here, the power value PTOTAL indicates power (dynamic power+static power) consumed by the processor 1000A (1).

The power capping control unit 14 outputs the down signal DOWN or the up signal UP such that the power value PTOTAL generated for each predetermined period does not exceed the power upper limit PLIMITT and performs power capping.

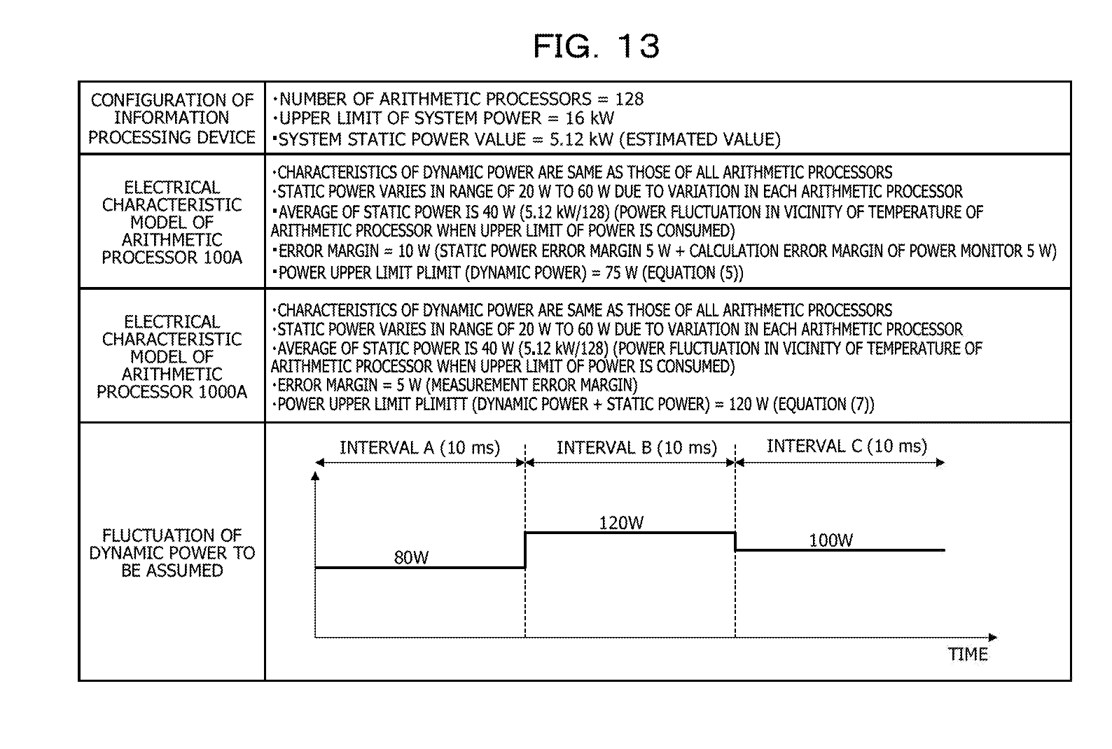

FIG. 13 illustrates an example the configurations and the electrical characteristics of the information processing apparatuses IPE2 and IPE 02 illustrated in FIGS. 6 and 12. It is assumed that each information processing apparatus IPE2 and IPE02 includes 128 arithmetic processors, the system power upper limit is 16 kW, and the system static power value is 5.12 kW (estimated value). In the information processing apparatus IPE2, it is assumed that the dynamic power error margin is 5 W and the calculation error margin of the monitor value PMON of dynamic power is 5 W. In the information processing apparatus IPE02, the measurement error margin is 5 W.

In addition, the electrical characteristic model of the respective information processing apparatuses IPE2 and IPE02 is as follows. The characteristics of dynamic power of all the arithmetic processors are the same as each other. The static power value varies in a range of 20 W to 60 W due to the variation for each arithmetic processor. The average of the static power value is 40 W obtained by dividing the system static power value (5.12 kW) by the number (128) of the arithmetic processors. The static power value is a value in the vicinity of the chip temperature at the time of the maximum power consumption.

The power upper limit PLIMIT (dynamic power) of each arithmetic processor 100A of the information processing apparatus IPE2 is 75 W according to Equation (5). The power upper limit PLIMITT (dynamic power+static power) of each arithmetic processor 1000A of the information processing apparatus IPE02 is 120 W according to Equation (7).

PLIMIT=system power upper limit/number of processors error margin (7)

Each of the arithmetic processors 100A and 1000A executes an application (job JOB) so that the dynamic power fluctuates as illustrated in FIG. 13. In the example illustrated in FIG. 13, the dynamic power in a section A is 80 W, the dynamic power in a section B is 120 W, and the dynamic power of a section C is 100 W. The lengths of the sections A, B, and C are respectively 10 milliseconds.

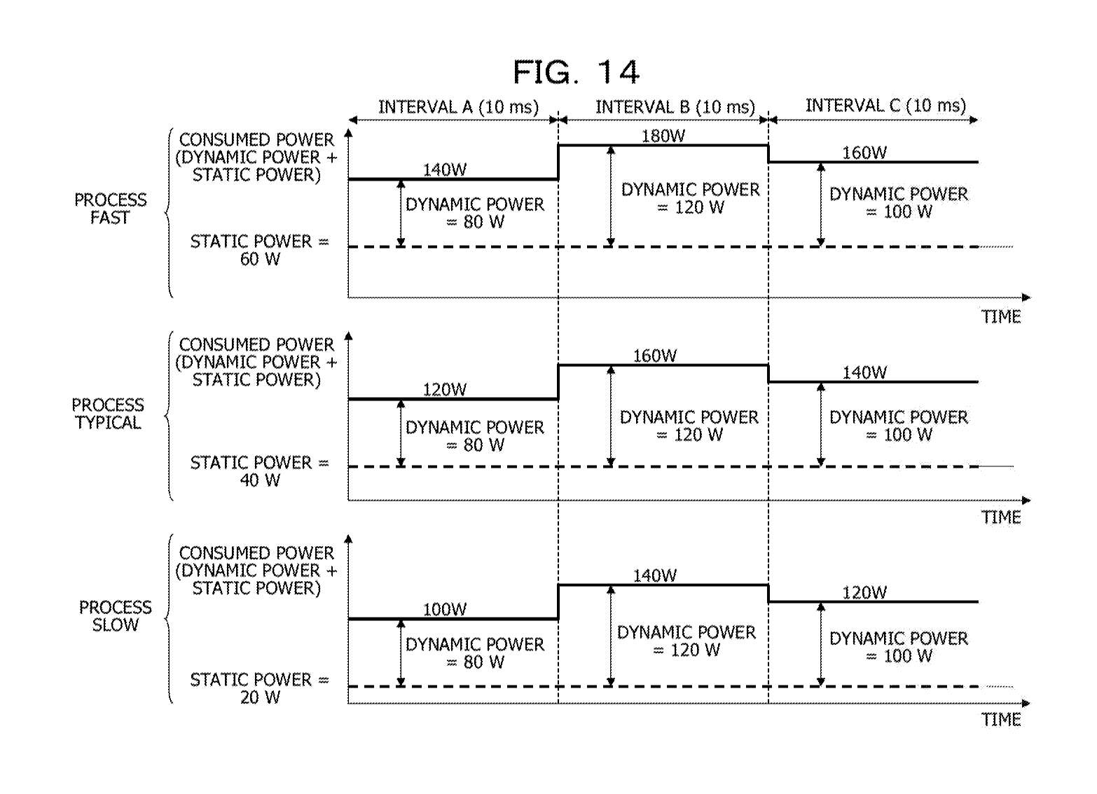

FIG. 14 illustrates an example of an operation model of the arithmetic processors 100A and 1000A illustrated in FIGS. 6 and 12. In FIG. 14, “process fast”, “process typical”, and “process slow” each indicate the process variation occurring during the process of manufacturing the processors 100A and 1000A.

In the “process fast”, the threshold voltage of transistors mounted on the processors 100A and 1000A is low and the static power (leakage power) thereof (60 W) is larger than other two. In the “process typical”, the threshold voltage of transistors mounted on the processors 100A and 1000A is standard and the static power thereof (40 W) is average. In the “process slow”, the threshold voltage of transistors mounted on the processors 100A and 1000A is large and the static power thereof (20 W) is smaller than other two.

The dynamic power of the respective processors 100A and 1000A does not depend on the process variation and the value thereof is 80 W in the section A, 120 W in the section B, and 100 W in the section C. Meanwhile, since the static power of respective processors 100A and 1000A depends on the process variation, the consumed power fluctuates depending on the static power in accordance with the process variation.

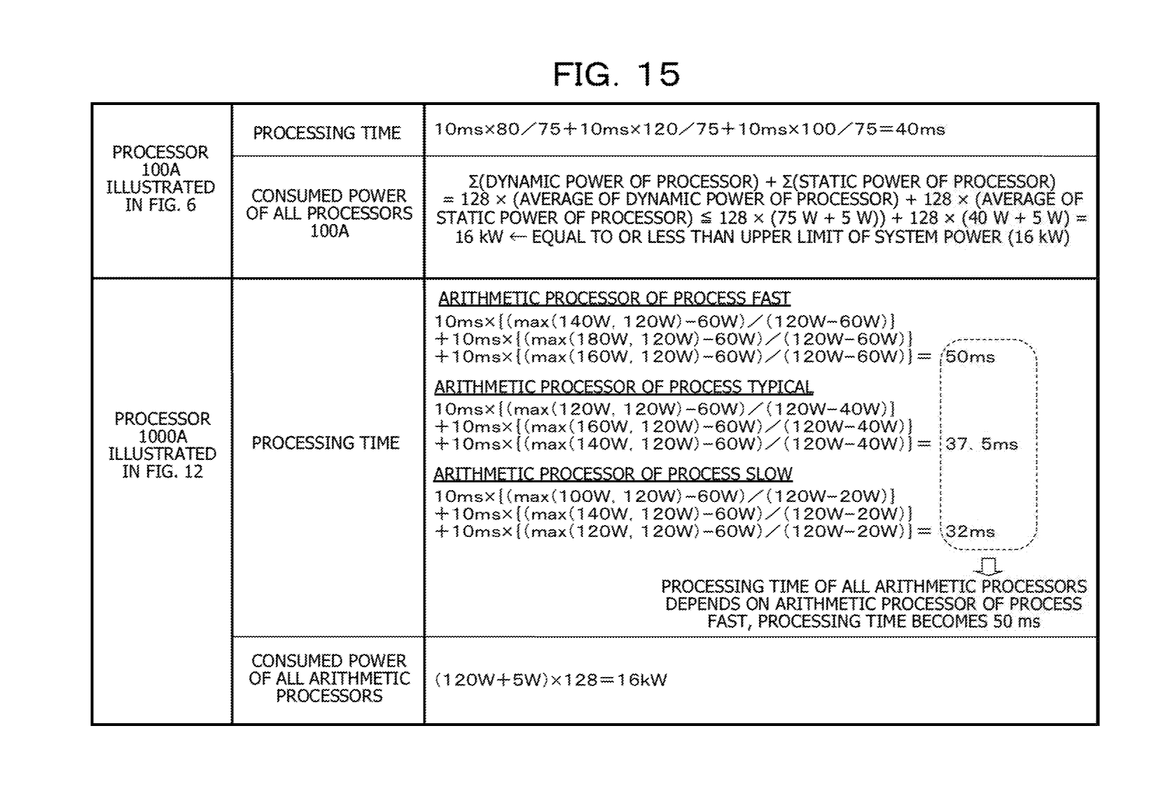

FIG. 15 illustrates an example of the processing time of the arithmetic processors 100A and 1000A illustrated in FIGS. 6 and 12.

In the processor 100A illustrated in FIG. 6, power capping is performed and the clock frequency is lowered when the dynamic power value exceeds the power upper limit PLIMIT (=75 W). In the operation model illustrated in FIG. 14, it is assumed that the clock frequency is lowered in proportion to the electric energy exceeding the power upper limit PLIMIT among the dynamic power values and the processing time is extended by an amount of a decrease in clock frequency. In this case, in each processor 100A, the total processing times in the sections A, B, and C are 40 milliseconds. Further, the total consumed power of all the processors 100A is 16 kW in maximum and the system power upper limit is satisfied.

Further, in the processor 1000A illustrated in FIG. 12, power capping is performed and the clock frequency is lowered when the consumed power exceeds the power upper limit PLIMITT (=120 W). In the operation model illustrated in FIG. 14, it is assumed that the clock frequency is lowered in proportion to the electric energy exceeding the power upper limit PLIMITT among the consumed power values and the processing time is extended by an amount of a decrease in clock frequency. In this case, the total processing times in the sections A, B, and C are 50 milliseconds in the processors 1000A of the process fast, 37.5 milliseconds in the processors 1000A of the process typical, and 32 milliseconds in the processors 1000A of the process slow. In a case where the processing times among the processors 1000A are different from each other, the synchronization waiting occurs as illustrated in FIG. 5B. Accordingly, the processing time of all the processors 1000A is 50 milliseconds depending on the processing time of the processors 1000A of the process fast. Further, the total consumed power of all the processors 1000A is 16 kW in maximum and the system power upper limit is satisfied.

As described above, in a case where the power capping is performed by the dynamic power value calculated using the common coefficient value FACT, the processing time can be reduced compared to a case where power capping is performed by the consumed power value calculated using the coefficient value FACT for each processor 1000A. In the example illustrated in FIG. 15, 20% (=(50 milliseconds−40 milliseconds)/50 milliseconds) of the processing time of the job JOB performed by the plurality of processors 100A in parallel can be improved.

Hereinbefore, the embodiments illustrated in FIGS. 6 to 15 can obtain the same effects as those of the embodiments illustrated in FIGS. 1 to 5. In other words, the processing times of arithmetic processing executed by the arithmetic processing devices 100A can be made equal to each other regardless of the process variation and occurrence of the waiting time for barrier synchronization for executing parallel processing in a synchronized manner can be reduced. As a result, in a case where the clock frequency is controlled by power capping, it is possible to suppress power consumption and degradation of processing performance. When power capping is performed by regarding each arithmetic processing device 100A as the standard arithmetic processing device, the average value of dynamic power actually consumed by the plurality of arithmetic processing devices 100A can be set to be approximately the same as the value of dynamic power consumed by the standard arithmetic processing device. Therefore, it is possible to inhibit the total value of power consumed by the arithmetic processing devices 100A from exceeding the upper limit of power accepted by the information processing apparatus IPE2 and to suppress degradation of reliability of the information processing apparatus IPE2. Moreover, the circuit scale of the processors 100A can be reduced compared to a case where power capping is performed using power values including static power values.

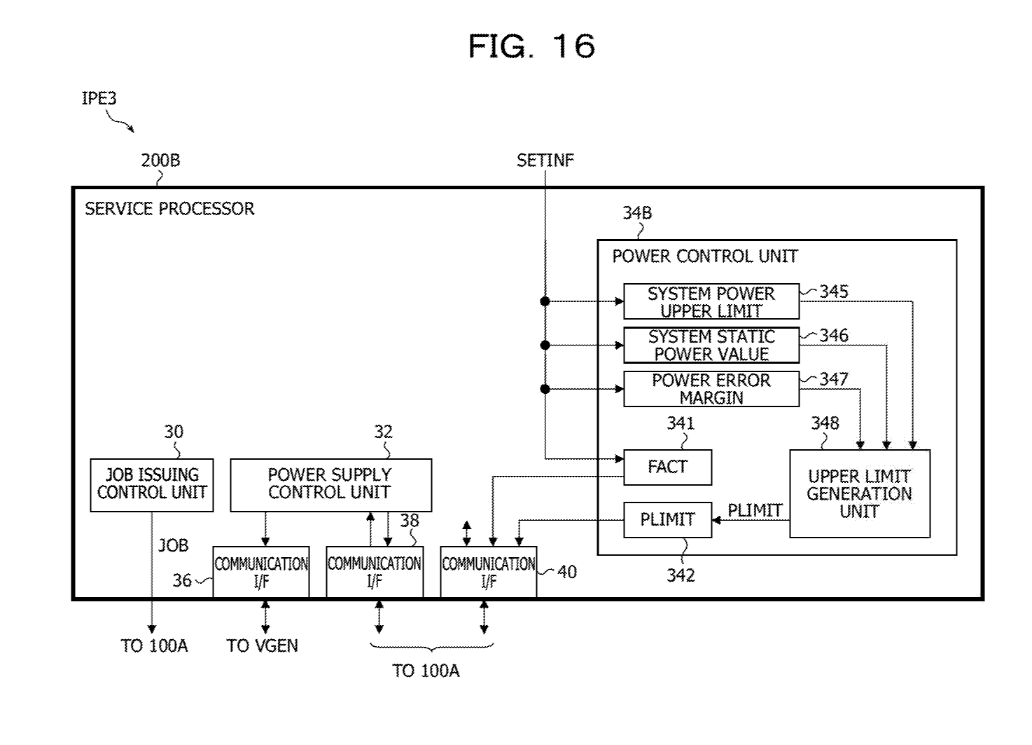

FIG. 16 is a diagram illustrating an example of the service processor in another embodiment of an information processing apparatus, an arithmetic processing device, and a method of controlling an information processing apparatus. The same or similar elements as the elements illustrated in FIGS. 1 and 6 are denoted by the same reference numerals and the detailed description thereof will not be repeated. A service processor 200B illustrated in FIG. 6 and the processors 100A illustrated in FIG. 6 are mounted on an information processing apparatus IPE3. The service processor 200B is an example of a control device.

The service processor 200B includes a power control unit 34B in place of the power control unit 34 of the service processor 200A illustrated in FIG. 6. Other configurations of the service processor 200B are the same as those of the service processor 200A illustrated in FIG. 6. The power control unit 34B has the configuration of the power control unit 34 illustrated in FIG. 6 and registers 345, 346, and 347 and an upper limit generation unit 34B are added thereto. Each unit such as the power control unit 34B may be formed as a hardware circuit or circuitry.

The register 345 holds the system power upper limit, the register 346 holds the system static power value, and the register 347 holds the error margin. The coefficient value FACT, the system power upper limit, the system static power value, and the error margin are supplied to the service processor 200B as the setting information SETINF at the time of activation of the information processing apparatus IPE3 and respectively stored in the registers 341, 345, 346, and 347. The coefficient value FACT and the system static power value are calculated in the same manner as in the description of FIG. 6.

The upper limit generation unit 34B calculates the power upper limit PLIMIT from the system power upper limit, the system static power value, and the error margin held by the registers 345, 346, and 347 based on Equation (5). The upper limit generation unit 34B stores the calculated power upper limit PLIMIT in the register 342. Further, the number of processors in Equation (5) may be held by the service processor 200B in advance and the power control unit 34B may include a register holding the number of processors. Since the power upper limit PLIMIT is generated by the upper limit generation unit 34B, the setting information SETINF does not include the power upper limit PLIMIT, which is different from the case in FIG. 6.

The operation of the processors 100A mounted on the information processing apparatus IPE3 illustrated in FIG. 16 is the same as in FIGS. 2B, 5A, 9, 10, and 11. That is, each processor 100A adjusts the clock frequency such that the monitor value PMON of dynamic power calculated based on the event signal EV and the coefficient value FACT does not exceed the power upper limit PLIMIT (dynamic power) and performs power capping control.

Hereinbefore, the embodiment illustrated in FIG. 16 can obtain the same effects as those of the embodiments illustrated in FIGS. 1 to 15. In other words, occurrence of the waiting time for barrier synchronization at the time of parallel processing by the arithmetic processing devices 100A can be reduced. Therefore, in a case where the clock frequency is controlled by power capping, it is possible to suppress power consumption and degradation of processing performance. Moreover, it is possible to inhibit the total value of power consumed by the arithmetic processing devices 100A from exceeding the upper limit of power accepted by the information processing apparatus IPE3 and to suppress degradation of reliability of the information processing apparatus IPE3. Further, the circuit scale of the processors 100A can be reduced compared to a case where power capping is performed using power values including static power values.

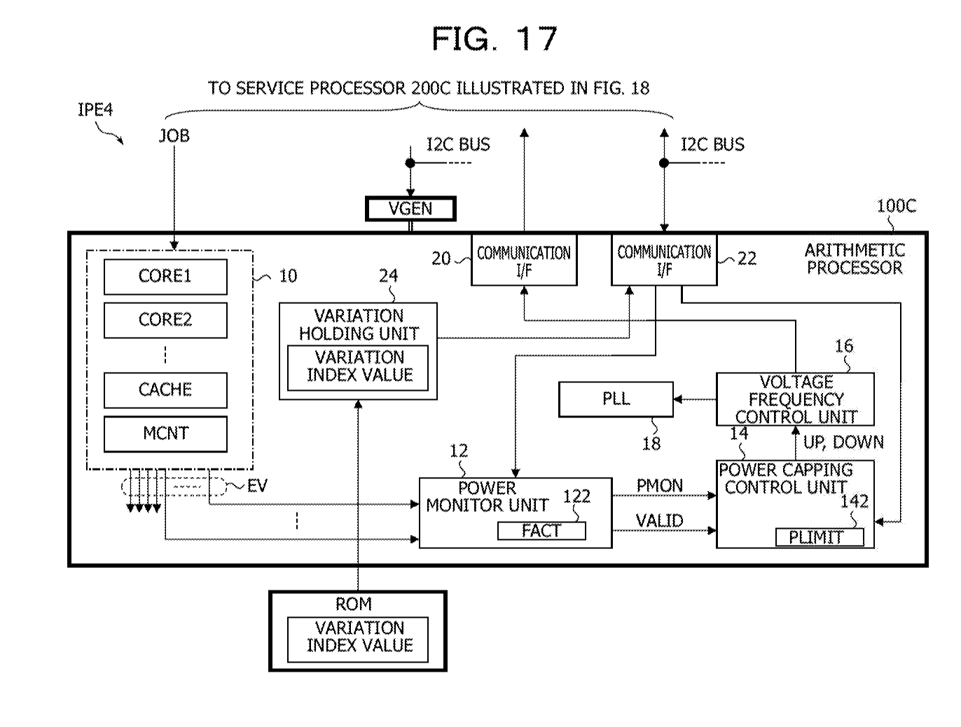

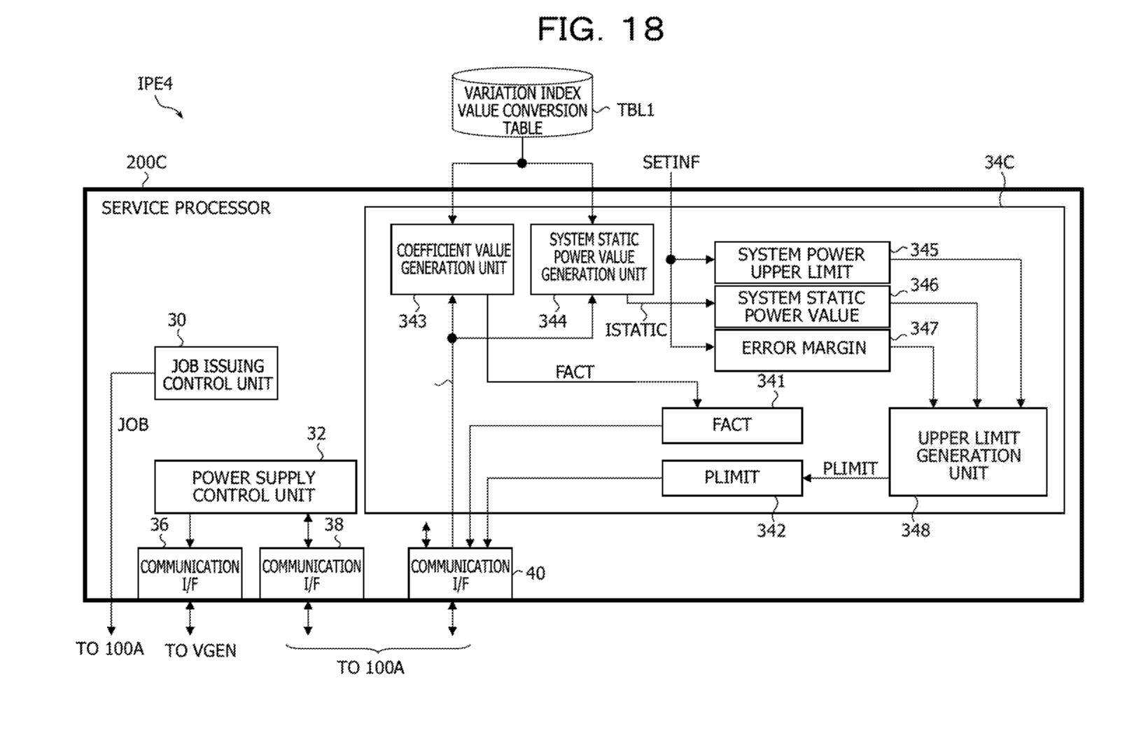

FIG. 17 is a diagram illustrating an example of the arithmetic processor in another embodiment of an information processing apparatus, an arithmetic processing device, and a method of controlling an information processing apparatus. The same or similar elements as the elements illustrated in FIGS. 6 and 16 are denoted by the same reference numerals and the detailed description thereof will not be repeated. An arithmetic processor 100C illustrated in FIG. 17 and a service processor 200C illustrated in FIG. 18 are mounted on an information processing apparatus IPE4. The arithmetic processor 100C is an example of the arithmetic processing device. The information processing apparatus IPE4 includes a plurality of arithmetic processors 100C which are capable of executing a job in parallel similar to the information processing apparatus IPE2 illustrated in FIG. 6. Hereinafter, the arithmetic processors 100C are also simply referred to as processors 100C.

The processors 100C have the configurations of the processors 100A illustrated in FIG. 6 and a variation holding unit 24 that holds variation index values is added thereto. The variation index value indicates the degree of variation with respect to a standard value of consumed power in accordance with the process variation occurring during the process of manufacturing the processors 100C. The variation index value is an example of deviation information related to consumed power of the processors 100C and the variation holding unit 24 is an example of the deviation information holding unit that holds deviation information. Each unit included in the processor 100C may be formed as a hardware circuit or circuitry.

For example, the degree of variation with respect to the standard value of consumed power can be represented by the degree (standard deviation) of variation with respect to the standard value such as the delay amount of an element acquired by an operation test after the processors 100C are manufactured, the source-drain current of transistors, or the threshold voltage. In addition, the variation index value (in other words, the degree of variation with respect to th standard value of consumed power) acquired by the operation test is stored in the ROM connected to the processors 100C.

The communication I/F 22 has a function of transmitting the variation index value output from the variation holding unit 24 to the service processor 200C in addition to a function of receiving the coefficient value FACT and the power upper limit PLIMIT from the service processor 200C. The arithmetic processors 100C have a function of storing the variation index value stored in the ROM in the variation holding unit 24 at the time of activation and reset release. Further, the variation index value may be stored in the ROM incorporated in the processors 100C. Other configurations and functions of the arithmetic processors 100C are the same as those of the arithmetic processors 100A illustrated in FIG. 6.

FIG. 18 illustrates an example of the service processor 200C connected to the arithmetic processors 100C illustrated in FIG. 17. The same or similar elements as the elements illustrated in FIG. 6 are denoted by the same reference numerals and the detailed description thereof will not be repeated. The service processor 200C is an example of a control device.

The service processor 200C includes a power control unit 34C in place of the power control unit 34B of the service processor 200B illustrated in FIG. 16. Other configurations of the service processor 200C are the same as those of the service processor 200B illustrated in FIG. 16. The power control unit 34C has the configuration of the power control unit 34B illustrated in FIG. 16 and a coefficient value generation unit 343 and a system static power value generation unit 344 are added thereto. Each unit included in the service processor 200C may be formed as a hardware circuit or circuitry.

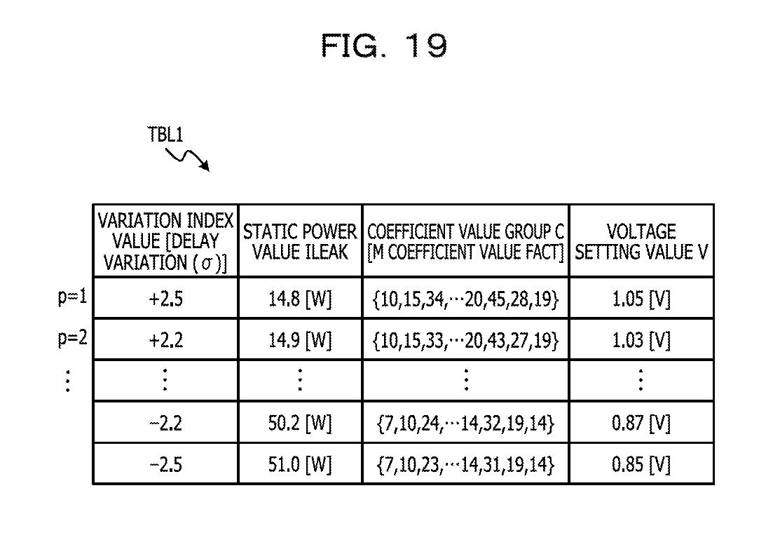

The coefficient value generation unit 343 receives variation index values from each processor 100C via the communication I/F 40 and reads coefficient value information corresponding to the received variation index values from a variation index value conversion table TBL1. In addition, the coefficient value generation unit 343 calculates the coefficient values FACT in accordance with the process variation for each processor 100C based on the coefficient value information read from the variation index value conversion table TBL1. An example of the variation index value conversion table TBL1 is illustrated in FIG. 19.

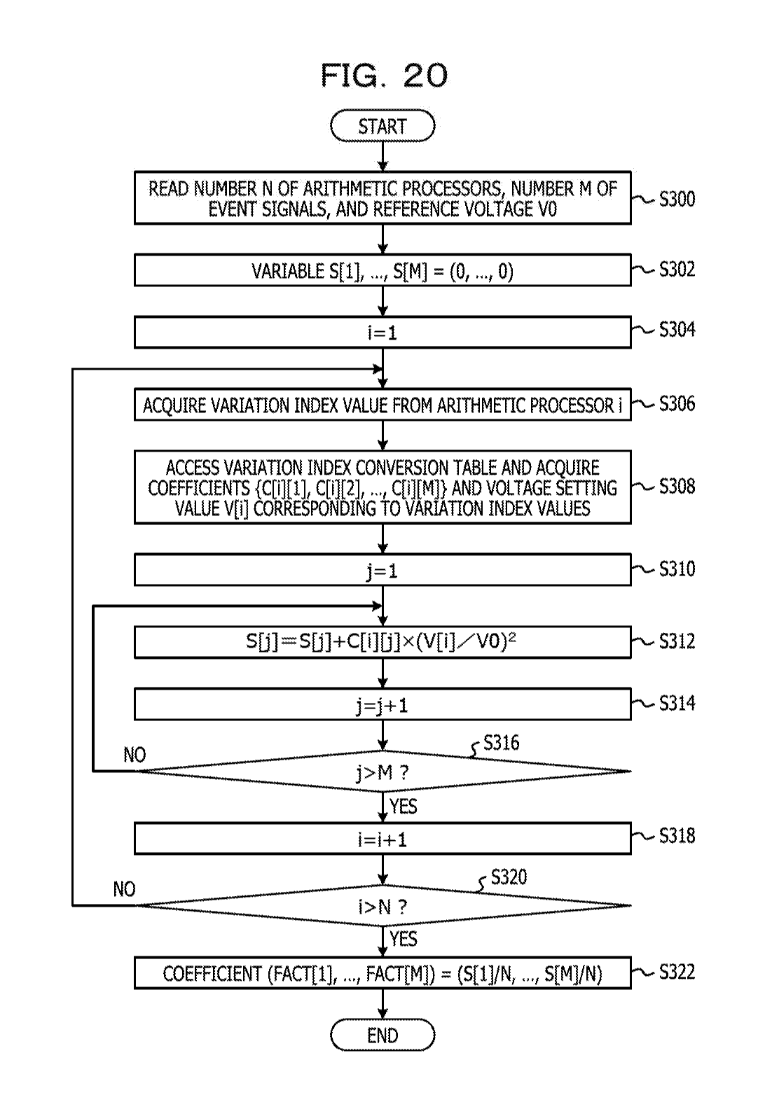

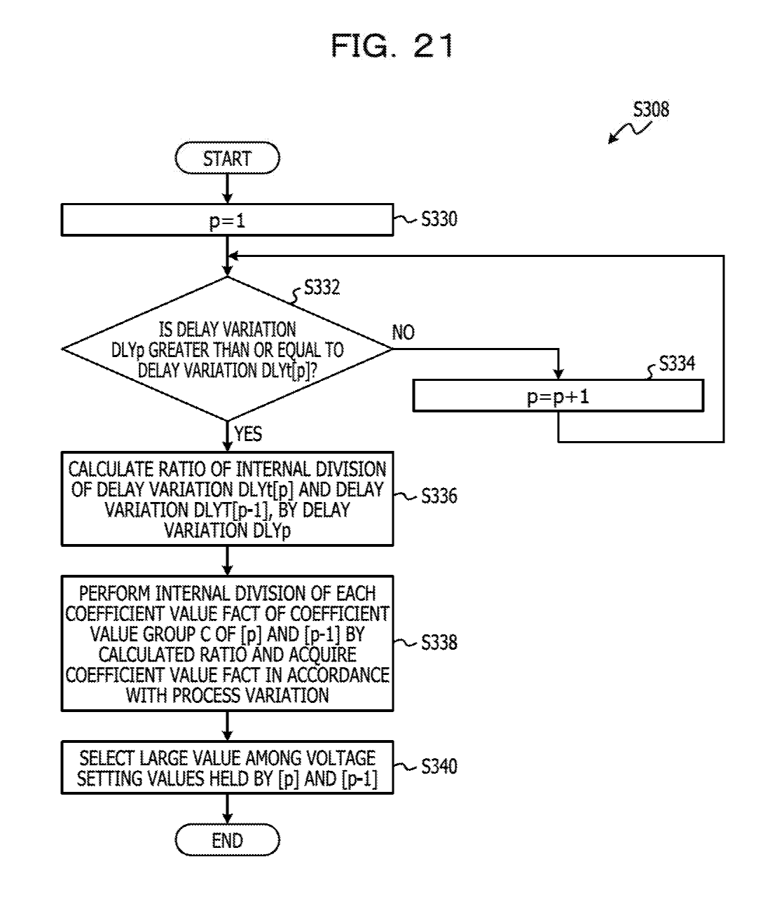

Further, the coefficient value generation unit 343 averages the calculated coefficient values FACT and stores the average coefficient value FACT in the register 341. That is, the service processor 200C calculates the average value of the coefficient values FACT based on the actual process variation of the processors 100C to be mounted on the information processing apparatus IPE4. Further, each processor 100C calculates the monitor value PMON of dynamic power using the average value of the coefficient values FACT. An example of the operation of the coefficient value generation unit 343 is illustrated in FIGS. 20 and 21.

The system static power value generation unit 344 receives variation index values from each processor 100C via the communication I/F 40 and reads static power information corresponding to the received variation index values from a variation index value conversion table TBL1. Moreover, the system static power value generation unit 344 calculates the static power value in accordance with the process variation for each processor 100C based on the static power information read from the variation index value conversion table TBL1.

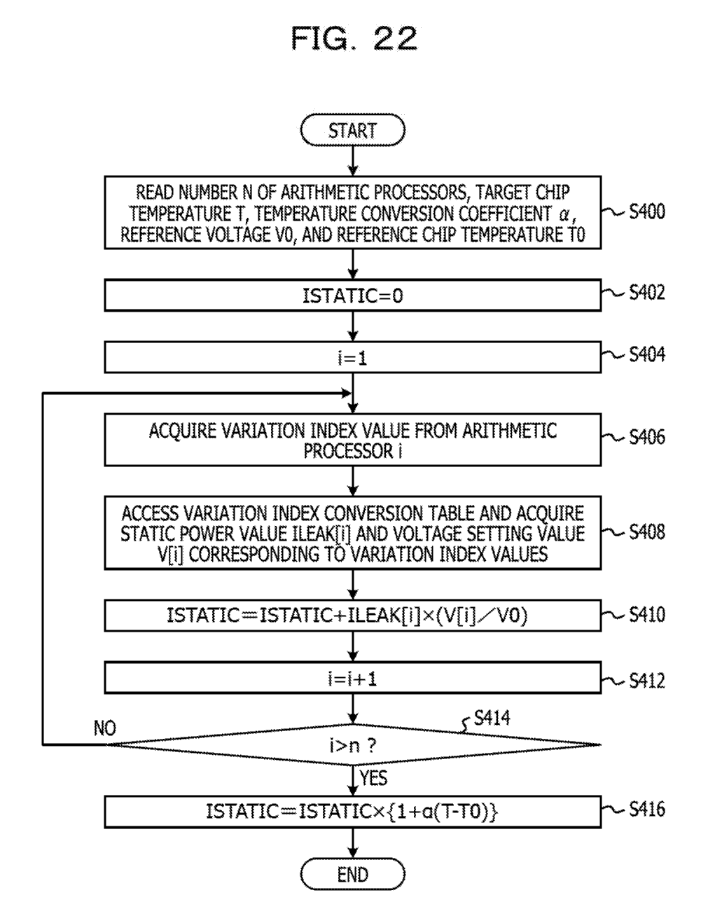

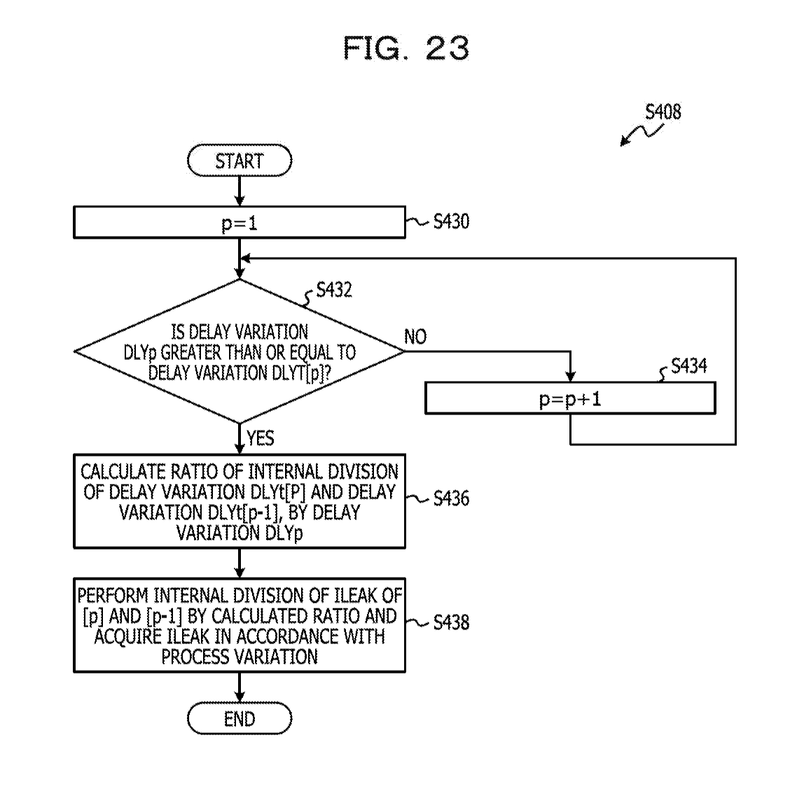

In addition, the system static power value generation unit 344 calculates the value of the system static power consumed by the plurality of processors 100C to be mounted on the information processing apparatus IPE4 by integrating the calculated static power value and stores the calculated system static power value ISTATIC in the register 346. The system static power value generation unit 344 is an example of a collection unit that collects each deviation information output by each processor 100A mounted on the information processing apparatus IPE4 and acquires the system static power value in accordance with the collected deviation information. An example of the operation of the system static power value generation unit 344 is illustrated in FIGS. 22 and 23.

Similar to FIG. 16, the registers 345 and 347 respectively hold the system power upper limit and the error margin received as the setting information SETINF from the outside of the service processor 200B. In addition, the upper limit generation unit 34B calculates the power upper limit PLIMIT from the system power upper limit, the system static power value, and the error margin held by the registers 345, 346, and 347 based on Equation (5). The upper limit generation unit 34B stores the calculated power upper limit PLIMIT in the register 342. Further, the number of processors in Equation (5) may be held by the service processor 200C in advance and the power control unit 34C may include a register holding the number of processors. Since the power upper limit PLIMIT is generated by the upper limit generation unit 34B and the system static power value is generated by the system static power value generation unit 244, the setting information SETINF does not include the power upper limit PLIMIT and the system static power value.

FIG. 19 illustrates an example of the variation index value conversion table TBL1 illustrated in FIG. 18. The variation index value conversion table TBL1 includes, for each of a plurality of variation index values, a static power value ILEAK, a coefficient value group C including M coefficient values FACT, and an entry holding a voltage setting value V. In the example illustrated in FIG. 19, the variation index value is represented by a standard deviation a of delay variation (variation in delay amount of an element). The coefficient value group C includes all coefficient values FACT used for calculation of dynamic power of the processors 100C. The voltage setting value V indicates a power supply voltage supplied to each processor 100A according to the process variation of each processor 100A.

The value p indicates an entry number. In the example illustrated in FIG. 19, the variation index values are held in an entry having a small value p as the delay amount of an element is larger. In other words, the variation index values are held in the variation index value conversion table TBL1 from the top to the bottom in a descending order of the delay amount of an element.

FIG. 20 illustrates an example of the operation of the coefficient value generation unit 343 illustrated in FIG. 18. For example, the operation illustrated in FIG. 20 is realized by an activation processing program executed at the time of activation and the reset release of the service processor 200C.

First, in Step S300, the coefficient value generation unit 343 reads the number N of arithmetic processors, the number M of event signals, and the reference voltage V0 from the ROM mounted on the service processor 200C. The number N of arithmetic processors is the number or arithmetic processors 100C mounted on the information processing apparatus IPE4. The number M of event signals is the number of event signals EV used for calculation of dynamic power in each arithmetic processor 100C and is the number of coefficient values FACT included in the coefficient value group C illustrated in FIG. 19. The reference voltage V0 is the reference value of the power supply voltage for setting the coefficient value FACT.

Next, in Step S302, the coefficient value generation unit 343 allocates M variables S and initialized the allocated variables S to “0”. Next, in Step S304, the coefficient value generation unit 343 sets the counter value i to “1”. Next, in Step S306, the coefficient value generation unit 343 acquires a variation index value from the i-th arithmetic processor 100C.

Next, in Step S308, the coefficient value generation unit 343 accesses the variation index value conversion table TBL1 and acquires a coefficient value group C[i] and a voltage setting value V[i] corresponding to the variation index value acquired from the arithmetic processor 100C. Further, the variation index value acquired from the arithmetic processor 100C occasionally does not match the variation index value of the variation index value conversion table TBL1. In this case, the coefficient value generation unit 343 executes internal division processing of internally dividing the coefficient value group C and the voltage setting value V stored in two entries adjacent to each other in the variation index value conversion table TBL1. An example of the internal division processing is illustrated in FIG. 21.

Subsequently, in Step S310, the coefficient value generation unit 343 sets the counter value j to “1”. Next, in Step S312, the coefficient value generation unit 343 corrects each element C[i][j] (that is, each coefficient value FACT) of the coefficient value group C acquired in Step S308 according to the power supply voltage supplied to the processor 100C. In addition, the coefficient value generation unit 343 adds the corrected element C[i][j] to a variable S[j].

Next, in Step S314, the coefficient value generation unit 343 increases the counter value j by “1”. Subsequently, in Step S316, in a case where the counter value j is less than or equal to the number M of the event signals, since the coefficient value generation unit 343 continues a process of adding the element C[i][j] to the variable S[j], the process returns to Step S312. Meanwhile, in a case where the counter value j exceeds the number M of event signals, since the processing of adding the element C[i][j] to the variable S[j], the coefficient value generation unit 343 advances the process to Step S318.

In Step S318, the coefficient value generation unit 343 increases the counter value i by “1”. Next, in Step S320, the coefficient value generation unit 343 calculates the coefficient values of the next arithmetic processor 100C in a case where the counter value i is less than or equal to the number N of arithmetic processors, the process returns to the Step S306. Meanwhile, since in a case where the coefficient values of all arithmetic processors 100C are calculated in a case where the counter value i is greater than the number N of arithmetic processors, the coefficient value generation unit 343 advances the process to Step S322.

In Step S322, the coefficient value generation unit 343 divides M variables S by the number N of arithmetic processors and the average of M coefficient values FACT in accordance with the process variation of a plurality of processors 100C to be mounted on the information processing apparatus IPE4. Further, the coefficient value generation unit 343 stores the calculated M coefficient values FACT in the register 341 illustrated in FIG. 18 and the process is finished.

FIG. 21 illustrates an example of internal division processing executed in Step S308 illustrated in FIG. 20. First, in Step S330, the coefficient value generation unit 343 sets the counter value p to “1”. The counter value p indicates the entry number of the variation index value conversion table TBL1 illustrated in FIG. 19.

Next, in Step S332, the coefficient value generation unit 343 advances the process to Step S336 in a case where delay variation DLYp represented by the variation index value received from the processor 100C is greater than or equal to delay variation DLYt(p) held by the entry p. The coefficient value generation unit 343 advances the process to Step S334 in a case where the delay variation represented by the variation index value received from the processor 100C is less than the delay variation held by the entry p.

In Step S334, the coefficient value generation unit 343 increases the counter value p by “1” and returns the process to Step S332. In Steps S332 and S334, an entry holding delay variation DLYt which is smaller than the delay variation DLYp received from the processor 100C and closest to the delay variation DLYp is selected. For example, in the variation index value conversion table TBL1 illustrated in FIG. 19, in a case where the delay variation DLYp is “+2.1”, the second entry (p=2) is selected.

In Step S336, the coefficient value generation unit 343 calculates a ratio of internal division of the delay variation DLYt[p] held by the selected entry p and the delay variation DLYt[p−1] held by the entry p−1, by the delay variation DLYp. For example, in a case where the delay variation received from the processor 100C is “+2.4”, the internal division ratio becomes “2:1”. Further, in a case where the delay variation received from the processor 100C is “+2.35”, the internal division ratio becomes “1:1”.

Next, in Step S338, the coefficient value generation unit 343 performs internal division on the coefficient values FACT held by the entries p and p−1 according to the ratio calculated in Step S336 and acquires the coefficient values FACT in accordance with the process variation of the processor 100C.

Next, in Step S340, the coefficient value generation unit 343 selects a large value among voltage setting values V held by the entries p and p−1 and finishes the process. Since the voltage setting values V are discrete values stored in the variation index value conversion table TBL1, a large value is selected among those without internal division.

FIG. 22 illustrates an example of the operation of the system static power value generation unit 344 illustrated in FIG. 18. For example, the operation illustrated in FIG. 22 is realized by the activation processing program executed at the time of activation and the reset release of the service processor 200C.

First, in Step S400, the system static power value generation unit 344 reads the number N of arithmetic processors, the target chip temperature T, the temperature conversion coefficient α, the reference voltage V0, and the reference chip temperature T0 from the ROM or the like mounted on the service processor 200C.

Next, in Step S402, the system static power value generation unit 344 initializes the variable ISTATIC storing the system static power values to “0”. Next, in Step S404, the system static power value generation unit 344 sets the counter value i to “1”.

Next, in Step S406, the system static power value generation unit 344 acquires the variation index value from the i-th arithmetic processor 100C. Subsequently, in Step S408, the system static power value generation unit 344 accesses the variation index value conversion table TBL1 and acquires the static power value ILEAK and the voltage setting value V corresponding to the variation index value acquired from the arithmetic processor 100C. Further, the variation index value acquired from the arithmetic processor 100C occasionally does not match the variation index value of the variation index value conversion table TBL1. In this case, the system static power value generation unit 344 executes internal division processing of internally dividing the static power value ILEAK and the voltage setting value V stored in two entries adjacent to each other in the variation index value conversion table TBL1. An example of the internal division processing is illustrated in FIG. 23.

Next, in Step S410, the system static power value generation unit 344 corrects the static power value ILEAK acquired in Step S408 according to the power supply voltage supplied to the processor 100C. In addition, the system static power value generation unit 344 adds the corrected static power value ILEAK to a variable ISTATIC (system static power value).

Next, in Step S412, the system static power value generation unit 344 increases the counter value i by “1”. Subsequently, in Step S414, in a case where the counter value i is less than or equal to the number N of arithmetic processors, since the static power value ILEAK of the next arithmetic processor 100C is acquired, the system static power value generation unit 344 returns the process to Step S406. Meanwhile, in a case where the counter value i exceeds the number N of arithmetic processors, since the static power values ILEAK of all arithmetic processors 100C are acquired and the system static power value is calculated, the system static power value generation unit 344 advances the process to Step S416.

In Step S416, the system static power value generation unit 344 corrects the system static power value represented by the variable ISTATIC using the target chip temperature T of the processor 100C. Further, the system static power value generation unit 344 stores the corrected system static power value in the register 346 illustrated in FIG. 18 and finishes the process.

FIG. 23 illustrates an example of internal division processing executed in Step S408 illustrated in FIG. 22. First, in Step S430, the system static power value generation unit 344 sets the counter value p representing the entry number of the variation index value conversion table TBL1 illustrated in FIG. 19 to “1”.

Next, in Step S432, the system static power value generation unit 344 advances the process to Step S436 in a case where delay variation DLYp represented by the variation index value received from the processor 100C is greater than or equal to delay variation DLYt(p) held by the entry p. The system static power value generation unit 344 advances the process to Step S434 in a case where the delay variation represented by the variation index value received from the processor 100C is less than the delay variation held by the entry p.

In Step S434, the system static power value generation unit 344 increases the counter value p by “1” and returns the process to Step S432. In Steps S432 and S434, an entry holding delay variation DLYt which is smaller than the delay variation DLYp received from the processor 100C and closest to the delay variation DLYp is selected.

In Step S436, the system static power value generation unit 344 calculates a ratio of internal division of the delay variation DLYt[p] held by the selected entry p and the delay variation DLYt[p−1] held by the entry p−1, by the delay variation DLYp. Next, in Step S438, the system static power value generation unit 344 performs internal division on the static power value ILEAK held by the entries p and p−1 according to the calculated ratio and acquires the static power value ILEAK in accordance with the process variation of the processor 100C. In addition, the process illustrated in FIG. 23 is finished.

Moreover, the static power value ILEAK, the coefficient value group C, and the voltage setting value V in accordance with the process variation for each processor 100C may be stored in the ROM connected to each processor 100C in advance. Further, the static power value ILEAK, the coefficient value group C, and the voltage setting value V are transferred to the service processor 200 from each processor 100C.

In this case, the coefficient value generation unit 343 omits the processes in Steps S306 and S308 illustrated in FIG. 20 and calculates the average value of the coefficient values FACT using the coefficient value group C and the voltage setting value V received from each processor 100C. Further, the system static power value correction unit 344 omits the processes in Steps S406 and S408 illustrated in FIG. 22 and calculates the system static power value ISTATIC using the static power value ILEAK and the voltage setting value V received from each processor 100C.

In this manner, the service processor 200C can calculate the coefficient value FACT and the system static power value ISTATIC without providing the variation index value conversion table TBL1 in the information processing apparatus IPE4. Further, the time for which the coefficient value generation unit 343 calculates the coefficient values FACT can be more reduced compared to the process illustrated in FIG. 20 and the time for which the system static power value correction unit 344 calculates the system static power value ISTATIC can be more reduced compared to the process illustrated in FIG. 22.

Hereinbefore, the embodiments illustrated in FIGS. 17 to 23 can obtain the same effects as those of the embodiments illustrated in FIGS. 1 to 15. In other words, occurrence of the waiting time for barrier synchronization at the time of parallel processing by the arithmetic processing devices 100C can be reduced. Therefore, in a case where the clock frequency is controlled by power capping, it is possible to suppress power consumption and degradation of processing performance. Moreover, it is possible to inhibit the total value of power consumed by the arithmetic processing devices 100C from exceeding the upper limit of power accepted by the information processing apparatus IPE4 and to suppress degradation of reliability of the information processing apparatus IPE4. Further, the circuit scale of the processors 100C can be reduced compared to a case where power capping is performed using power values including static power values.

In addition, in the embodiments illustrated in FIGS. 17 to 23, the service processor 200C calculates the coefficient value FACT based on the actual process variation of the processor 100C to be actually mounted on the information processing apparatus IPE4. In addition, the processor 100C calculates the monitor value PMON which is the dynamic power using the coefficient value FACT calculated by the service processor 200C. In this manner, it is possible to make the monitor value PMON calculated by the power monitor unit 12 close to the average value of dynamic power of the processor 100C actually mounted on the information processing apparatus IPE4 and to improve the precision of power capping compared to the embodiments illustrated in FIGS. 1 to 15.

Further, the service processor 200C calculates the system static power value ISTATIC based on the actual process variation of the processor 100C to be actually mounted on the information processing apparatus IPE4. In addition, the service processor 200C calculates the power upper limit PLIMIT using the calculated system static power value ISTATIC. In this manner, it is possible to improve the precision of power upper limit PLIMIT used for power capping compared to the embodiments illustrated in FIGS. 1 to 15 so that power capping can be accurately performed.

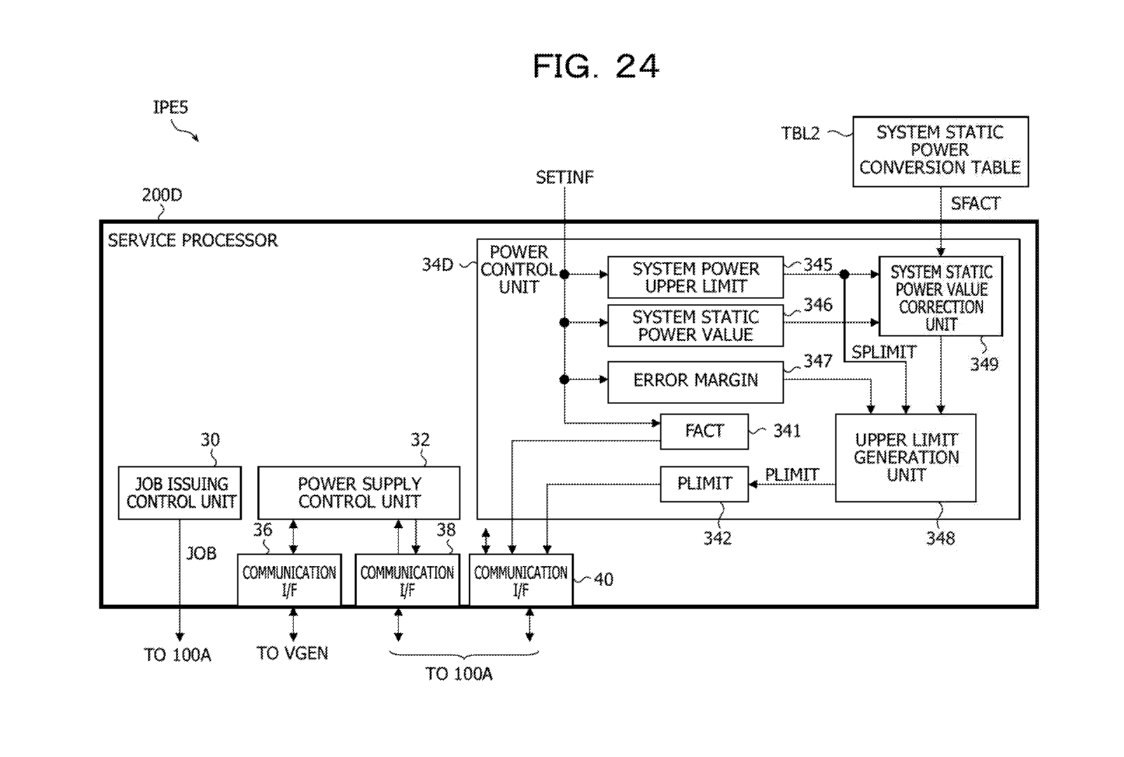

FIG. 24 illustrates an example of the service processor in another embodiment of an information processing apparatus, an arithmetic processing device, and a method of controlling an information processing apparatus. The same or similar elements as the elements illustrated in FIGS. 6 and 16 are denoted by the same reference numerals and the detailed description thereof will not be repeated. A service processor 200D illustrated in FIG. 24 is mounted on an information processing apparatus IPE5 together with a plurality of processors 100A which are capable of executing a job illustrated in FIG. 6 in parallel. Further, in the embodiment illustrated in FIG. 24, it is preferable that the number of processors 100A mounted on the information processing apparatus IPE5 is sufficiently large so that the error is small enough to be negligible even when the variation in power is statistically dealt with.

The service processor 200D includes a power control unit 34D in place of the power control unit 34B of the service processor 200B illustrated in FIG. 16. The service processor 200D is an example of a control device. Other configurations of the service processor 200D are the same as those of the service processor 200B illustrated in FIG. 16. The power control unit 34D has the configuration of the power control unit 34B illustrated in FIG. 16 and a system static power value correction unit 349 is added thereto. Further, the coefficient values FACT and the system static power values respectively stored in the registers 341 and 346 are calculated in the same manner as in the description of FIG. 6. Each unit included in the service processor 200D may be formed as a hardware circuit or circuitry.

The power upper limit PLIMIT (dynamic power) accepted by each processor 100A is changed when the system power upper limit SPLIMIT is changed. The system power upper limit SPLIMIT is changed according to the capacity of a power supply unit that supplies power to the information processing apparatus IPE5 or changed according to the number of information processing apparatuses IPE5 connected to the power supply unit. In a case where the power upper limit PLIMIT is increased due to an increase of the system power upper limit SPLIMIT and the clock frequency is increased by each processor 100A, the chip temperature is increased. Meanwhile, in a case where the power upper limit PLIMIT is decreased due to a decrease of the system power upper limit SPLIMIT and the clock frequency is decreased by each processor 100A, the chip temperature is decreased. Since the system static power value (leakage power value) varies depending on the chip temperature, in a case where the system power upper limit SPLIMIT is changed, it is preferable that the system static power value is corrected according to the change of the system power upper limit SPLIMIT.

The system static power value correction unit 349 refers to a system static power conversion table TBL2 based on the system power upper limit SPLIMIT stored in the register 345 and acquires a static power conversion coefficient SFACT. The system static power value correction unit 349 corrects the system static power value stored in the register 346 using the acquired static power conversion coefficient SFACT and outputs the corrected system static power value to the upper limit generation unit 34B. In this manner, even in a case where the chip temperature of the processor 100A is changed according to the change of the system power upper limit SPLIMIT and the leakage power value of the processor 100A is changed, the system static power value can be corrected according to the changing leakage power value.

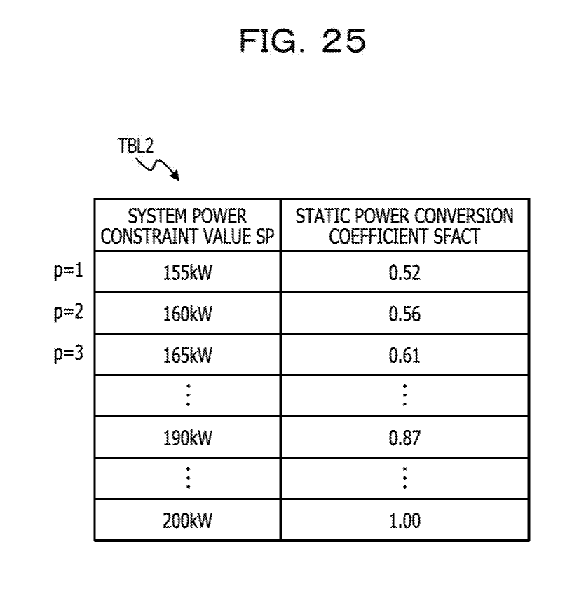

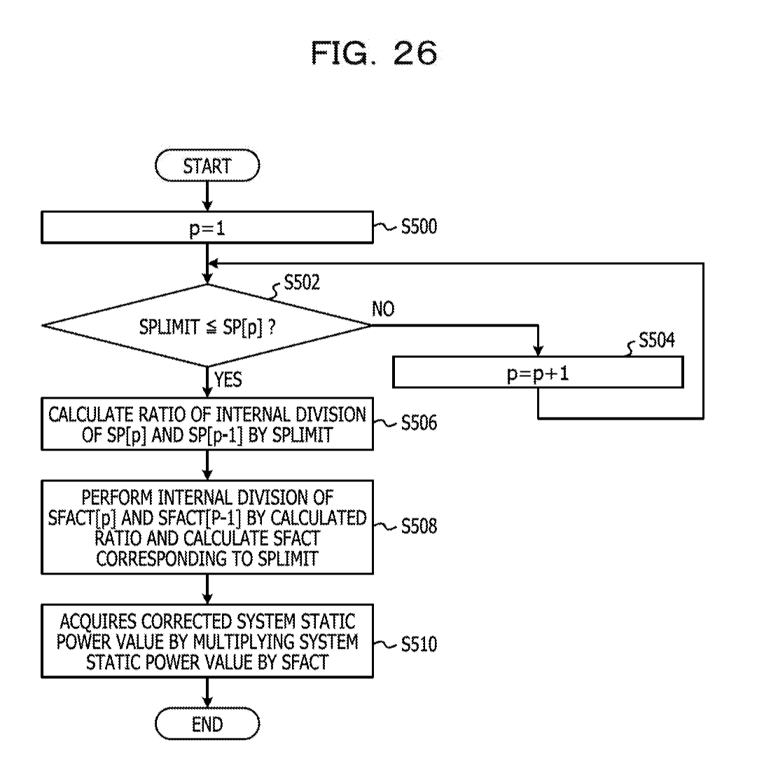

The upper limit generation unit 34B calculates the power upper limit PLIMIT (dynamic power) using Equation (5) based on the system static power value corrected by the system static power value correction unit 349. In this manner, it is possible to accurately calculate the power upper limit PLIMIT (dynamic power) with a small error according to the leakage power value that is changed when the chip temperature is changed. The example of the system static power conversion table TBL2 is illustrated in FIG. 25 and the example of the operation of the system static power value correction unit 349 is illustrated in FIG. 26.

Moreover, the service processor 200D may include the coefficient value generation unit 343 and the system static power value generation unit 344 similar to the service processor 200C illustrated in FIG. 18. In this case, the information processing apparatus IPE5 includes the processor 100C illustrated in FIG. 17 in place of the processor 100A illustrated in FIG. 6 and also includes the same variation index value conversion table TBL1 as in FIG. 18. Further, the coefficient value FACT generated by the coefficient value generation unit 343 is stored in the register 341 and the system static power value generated by the system static power value generation unit 344 is stored in the register 346.

FIG. 25 illustrates an example of the system static power conversion table TBL2 illustrated in FIG. 24. The system static power conversion table TBL2 has an entry holding the static power conversion coefficient SFACT for each of a plurality of system power constraint values SP representing various system power upper limits SPLIMIT. The value p indicates an entry number. In the example illustrated in FIG. 25, the static power conversion coefficient SFACT is held in an entry having a large value p as the system power constraint value SP is larger.

For example, in a case where the system power upper limit SPLIMIT is 160 kW, the system static power value correction unit 349 illustrated in FIG. 24 selects the static power conversion coefficient SFACT (=0.56) stored in the same entry as the system power constraint value SP whose system power upper limit SPLIMIT is 160 kW. The system static power value correction unit 349 corrects the system static power value by multiplying the selected static power conversion coefficient SFACT by the system static power value. In addition, in a case where the system power upper limit SPLIMIT is between system power constrain values SP stored in two entries adjacent to each other, the system static power value correction unit 349 internally divides the two system power constrain values SP by the system power upper limit SPLIMIT. In addition, the system static power value correction unit 349 calculates the static power conversion coefficient SFACT corresponding to the system power constrain values SP obtained by internal division (interpolation processing). The interpolation processing will be described in FIG. 26.

FIG. 26 illustrates an example of the operation of the system static power value correction unit 349 illustrated in FIG. 24. For example, the operation illustrated in FIG. 26 is realized by the activation processing program executed at the time of activation and the reset release of the service processor 200D. Further, the operation illustrated in FIG. 26 may be performed based on a change in the system power upper limit.

First, in Step S500, the system static power value correction unit 349 sets the counter value p indicating the entry number of the system static power conversion table TBL2 to “1”. Next, in Step S502, in a case where the system power upper limit SPLIMIT stored in the register 345 is less than or equal to the system power constraint value SP held by the entry p, the system static power value correction unit 349 advances the process to Step S506. In a case where the system power upper limit SPLIMIT is greater than the system power constraint value SP held by the entry p, the system static power value correction unit 349 advances the process to Step S504.

In Step S504, the system static power value correction unit 349 increases the counter value p by “1” and returns the process to Step S502. In Steps S502 and S504, an entry holding the system power constraint value SP which is greater than or equal to the system power upper limit SPLIMIT and closest to the system power upper limit SPLIMIT is selected. For example, in the system static power conversion table TBL2 illustrated in FIG. 25, in a case where the system power upper limit SPLIMIT is 162 W, the third entry (p=3) is selected.

In Step S506, the system static power value correction unit 349 calculates a ratio of internal division of the system power constraint value SP[p] held by the selected entry p and the system power constraint value SP[p−1] held by the entry p−1, by the system power upper limit SPLIMIT. For example, in a case where the system power upper limit SPLIMIT is 162 W, the internal division ratio becomes “3:2”. Further, in a case where the system power upper limit SPLIMIT is 164 W, the internal division ratio becomes “1:4”.

Next, in Step S508, the system static power value correction unit 349 performs internal division on the static power conversion coefficient SFACT held by the entries p and p−1 according to the calculated ratio and acquires the static power conversion coefficient SFACT corresponding to the system power upper limit SPLIMIT.

Next, in Step S510, the system static power value correction unit 349 acquires the corrected system power upper limit SPLIMIT by multiplying the system power upper limit SPLIMIT by the static power conversion coefficient SFACT. The system static power value correction unit 349 outputs the acquired system power upper limit SPLIMIT to the upper limit generation unit 34B.

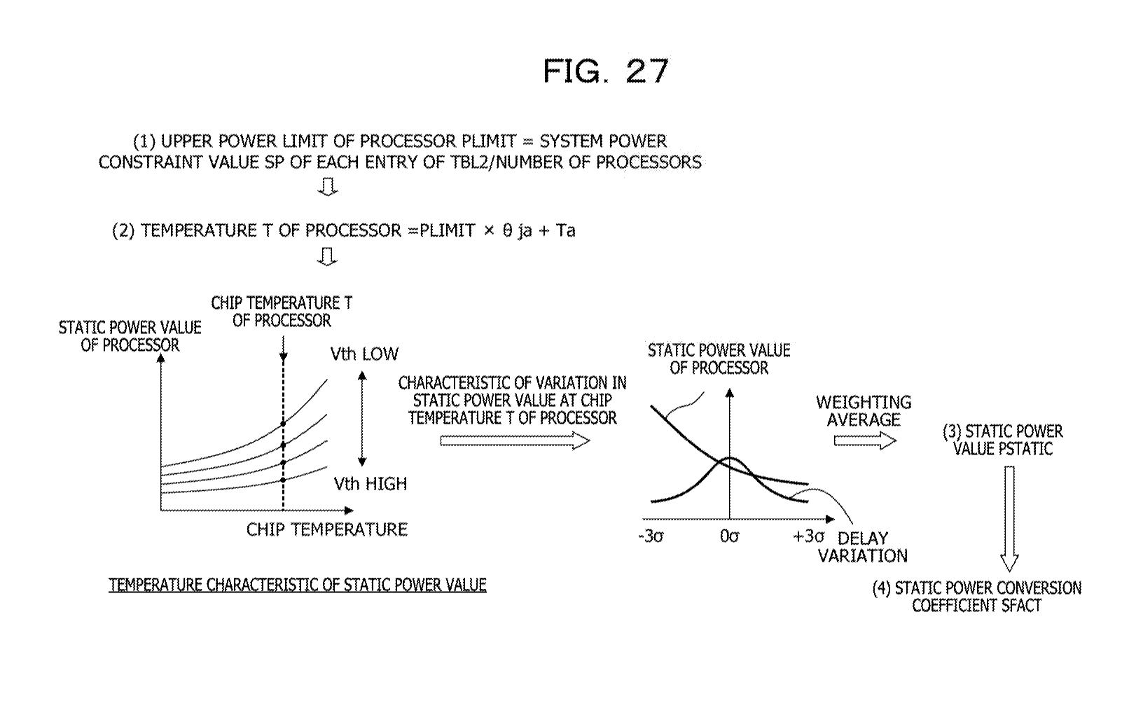

FIG. 27 illustrates an example of a method of creating information stored in the system static power conversion table TBL2 illustrated in FIG. 24. For example, at the time of designing the processor 100A or the information processing apparatus IPE5, the information stored in the system static power conversion table TBL2 is created in the following manner.

(1) The power upper limit PLIMIT of the processor 100A for each entry is calculated by dividing the system power constraint value SP in each entry of the system static power conversion table TBL2 by the number of processors 100A mounted on the information processing apparatus IPE5.

(2) The temperature (chip temperature) of the processor 100A for each entry is calculated by adding an outside air temperature Ta to a value obtained by multiplying a thermal resistance θja of the processor 100A containing a molding material or the like of a package on which the processor 100A is mounted by the power upper limit PLIMIT.

(3) An average static power value PSTATIC in which the fluctuation due to the process variation of the static power value at the calculated chip temperature is weighted by the probability density is calculated for each entry based on the temperature characteristic (for each process variation) of the static power value of the processor 100A. Here, the process variation is correlated with the variation in threshold voltage of transistors to be mounted on the processor 100A and the variation in delay amount of an element.

(4) The static power conversion coefficient SFACT in an entry of the maximum value SPmax (200 kW in FIG. 25) of the system power constraint value SP is set to “1.0”. Further, the static power conversion coefficient SFACT in another entry is calculated based on a ratio of the average static power value PSTATIC at the maximum value SPmax to the average static power value PSTATIC in another entry. Further, the calculated static power conversion coefficient SFACT in each entry is stored in the system static power conversion table TBL2.

Hereinbefore, the embodiments illustrated in FIGS. 24 to 27 can obtain the same effects as those of the embodiments illustrated in FIGS. 1 to 15. In other words, occurrence of the waiting time for barrier synchronization at the time of parallel processing by the arithmetic processing devices 100A can be reduced. Therefore, in a case where the clock frequency is controlled by power capping, it is possible to suppress power consumption and degradation of processing performance. Moreover, it is possible to inhibit the total value of power consumed by the arithmetic processing devices 100A from exceeding the upper limit of power accepted by the information processing apparatus IPE5 and to suppress degradation of reliability of the information processing apparatus IPE5. Further, the circuit scale of the processors 100A can be reduced compared to a case where power capping is performed using power values including static power values.

Further, in the embodiments illustrated in FIGS. 24 to 27, even in a case where the chip temperature of the processor 100A is changed according to the change of the system power upper limit SPLIMIT, the system static power value can be corrected according to the changing leakage power value depending on the chip temperature. In this manner, it is possible to improve the precision of power upper limit PLIMIT used for power capping compared to the embodiments illustrated in FIGS. 1 to 15 so that power capping can be accurately performed.

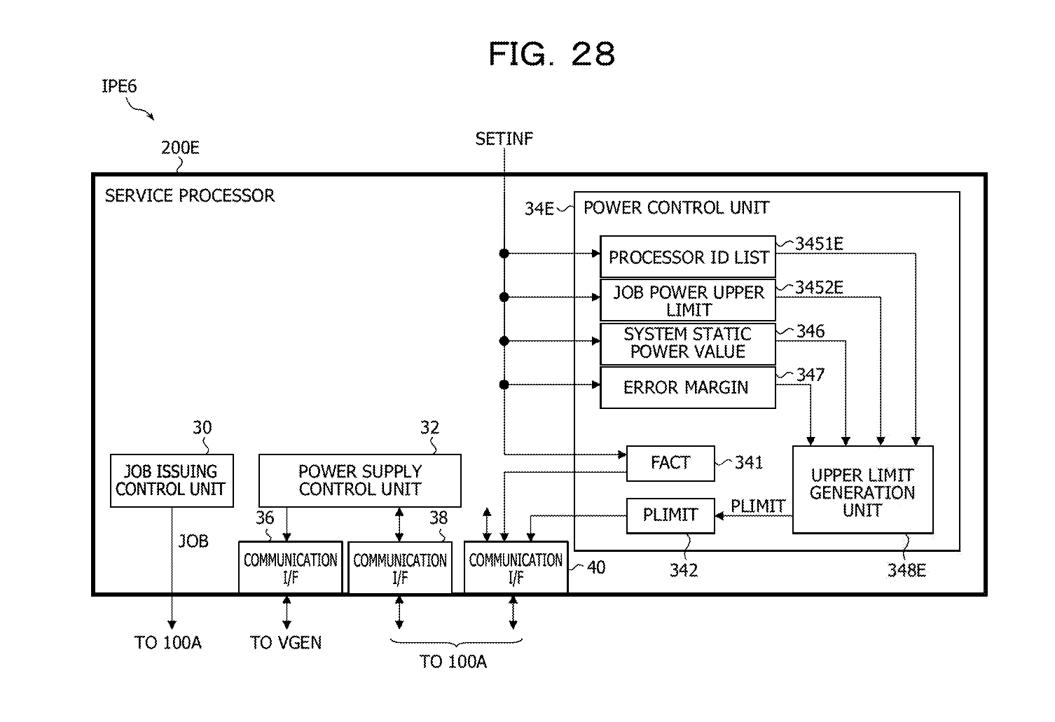

FIG. 28 illustrates an example of the service processor in another embodiment of an information processing apparatus, an arithmetic processing device, and a method of controlling an information processing apparatus. The same or similar elements as the elements illustrated in FIGS. 6 and 16 are denoted by the same reference numerals and the detailed description thereof will not be repeated. A service processor 200E illustrated in FIG. 28 is mounted on an information processing apparatus IPE6 together with a plurality of processors 100A which are capable of executing a job illustrated in FIG. 6 in parallel. The service processor 200E is an example of a control device.

The service processor 200E includes a power control unit 34E in place of the power control unit 34B of the service processor 200B illustrated in FIG. 16. Other configurations of the service processor 200E are the same as those of the service processor 200B illustrated in FIG. 16. The power control unit 34E includes registers 3451E and 3452E in place of the register 345 of the power control unit 34B illustrated in FIG. 16 and an upper limit generation unit 348E in place of the upper limit generation unit 34B of the power control unit 34B illustrated in FIG. 16. Further, the coefficient values FACT and the system static power values respectively stored in the registers 341 and 346 are calculated in the same manner as in the description of FIG. 6. Each unit included in the service processor 200E may be formed as a hardware circuit or circuitry.

The register 3451E holds a processor ID list indicating the processor 100A executing the job JOB and the register 3452E holds the job power upper limit which is the upper limit of dynamic power accepted by the processor 100A executing the job JOB.

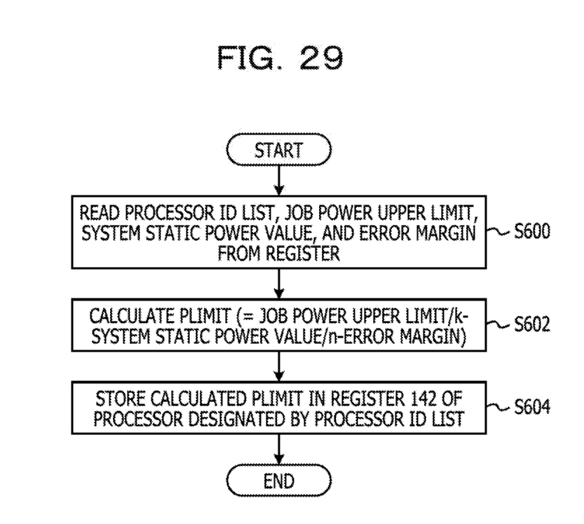

The upper limit generation unit 34BE calculates the power upper limit PLIMIT of dynamic power based on the processor ID list, the job power upper limit, the system static power value, and the error margin respectively held by the registers 3451E, 3452E, 346, and 347. That is, the upper limit generation unit 34BE calculates the power upper limit PLIMIT of a predetermined number of processors 100A executing the job JOB in parallel among the processors 100A to be mounted on the information processing apparatus IPE6. The number of processors 100A executing the job JOB in parallel is calculated from the processor ID list. For example, when the number of processors 100A executing the job JOB in parallel is increased, the power upper limit PLIMIT is decreased. When the number of processors 100A executing the job JOB in parallel is decreased, the power upper limit PLIMIT is increased. An example (that is, a method of acquiring the power upper limit PLIMIT) of the operation of the upper limit generation unit 34BE is illustrated in FIG. 29.

FIG. 29 illustrates an example of the operation of the power control unit 34E illustrated in FIG. 28. For example, the operation illustrated in FIG. 29 is realized by the activation processing program executed at the time of activation and the reset release of the service processor 200E.

First, in Step S600, the upper limit generation unit 34BE of the power control unit 34E reads the processor ID list, the job power upper limit, the system static power value, and the error margin respectively held by the registers 3451E, 3452E, 346, and 347.

Next, in Step S602, the upper limit generation unit 34BE calculates the power upper limit PLIMIT using Equation (8). In Equation (8), the number k of execution processors is the number of processors 100A included in the processor ID list held by the register 3451E and the number of mounted processors is the number of processors 100A to be mounted on the information processing apparatus IPE6. The upper limit generation unit 34BE stores the calculated power upper limit PLIMIT in the register 342.

PLIMIT=job power upper limit/number k of execution processors−system static power value/number n of mounted processors−error margin (8)

Next, in Step S604, the power control unit 34E stores the power upper limit PLIMIT stored in the register 342 in the register 142 (FIG. 6) of the power capping control unit 14 in the processor 100A to be designated by the processor ID list and finishes the operation.

Hereinbefore, the embodiments illustrated in FIGS. 28 and 29 can obtain the same effects as those of the embodiments illustrated in FIGS. 1 to 15. In other words, occurrence of the waiting time for barrier synchronization at the time of parallel processing by the arithmetic processing devices 100A can be reduced. Therefore, in a case where the clock frequency is controlled by power capping, it is possible to suppress power consumption and degradation of processing performance. Moreover, it is possible to inhibit the total value of power consumed by the arithmetic processing devices 100A from exceeding the upper limit of power accepted by the information processing apparatus IPE6 and to suppress degradation of reliability of the information processing apparatus IPE6. Further, the circuit scale of the processors 100A can be reduced compared to a case where power capping is performed using power values including static power values.

Further, in the embodiments illustrated in FIGS. 28 and 29, even in a case where the number of processors 100A executing the job JOB in parallel is changed, the power upper limit PLIMIT can be calculated according to the change of the number of processors 100A. In this manner, it is possible to perform power capping using the power upper limit PLIMIT in accordance with the number of processors 100A executing the job JOB in parallel. As a result, the precision of the power capping can be more improved compared to a case where the power upper limit PLIMIT is not changed even when the number of processors 100A executing the job JOB in parallel is changed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention. For example, the steps recited in any of the process or method descriptions may be executed in any order and are not limited to the order presented.

What is claimed is:

1. An information processing apparatus comprising:
a plurality of arithmetic processing devices,
wherein the arithmetic processing device comprises
an arithmetic processing circuit configured to execute arithmetic processing and generate a plurality of event signals corresponding to events executed in the arithmetic processing;
a plurality of coefficient value holding circuitry respectively configured to hold a coefficient value corresponding to any one of events to be executed by the arithmetic processing circuit;
an accumulated value holding circuit configured to hold an accumulated value obtained by using one or more of the coefficient values held by specified coefficient value holding circuitry from among the plurality of coefficient value holding circuitry, the specified coefficient value holding circuitry corresponding to the plurality of event signals generated by the arithmetic processing circuit;
a power upper limit holding circuit configured to hold power upper limits of each arithmetic processing device which correspond to a system power upper limit which is the power upper limit of the information processing apparatus; and
a control circuit configured to control at least one of a voltage and a frequency of each of the arithmetic processing devices such that the accumulated value held by the accumulated value holding circuit does not exceed the power upper limit held by the power upper limit holding circuit.

2. The information processing apparatus according to claim 1,
wherein the predetermined coefficient values respectively held by the plurality of coefficient value holding circuitry are commonly set in the plurality of arithmetic processing devices.

3. The information processing apparatus according to claim 2, further comprising:
a control device configured to control the plurality of arithmetic processing devices,
wherein the control device includes an upper limit generation circuit that generates power upper limits of each arithmetic processing device from the system power upper limit, and
wherein the power upper limit holding circuit of each of the arithmetic processing devices holds power upper limits generated by the upper limit generation circuit.

4. The information processing apparatus according to claim 3,
wherein the upper limit generation circuit of the control device generates a dynamic power upper limit which is the upper limit of dynamic power consumed by an operation of each of the arithmetic processing devices by dividing a system dynamic power upper limit, obtained by subtracting a system static power value that is the total of static power values consumed by the plurality of arithmetic processing devices from the system power upper limit, by the number of the arithmetic processing devices, and
wherein the power upper limit holding circuit of each of the arithmetic processing devices holds a dynamic power upper limit generated by the upper limit generation circuit as a power upper limit.

5. The information processing apparatus according to claim 4,
wherein each of the arithmetic processing devices further includes a deviation information holding circuit that holds deviation information related to power consumption of an own arithmetic processing device, which is output to the control device,
wherein the control device further includes a collection circuit that collects each deviation information output by each of the arithmetic processing devices and acquires the system static power value in accordance with the collected deviation information, and
wherein the upper limit generation circuit generates dynamic power upper limits of each of the arithmetic processing devices based on the system power upper limit and the system static power value acquired by the collection circuit.

6. The information processing apparatus according to claim 5,
wherein the control device further includes a coefficient value generation circuit that collects each deviation information output by each of the arithmetic processing devices and acquires coefficient values in accordance with the collected deviation information.

7. The information processing apparatus according to claim 2,
wherein the control device further includes a system static power value correction circuit that corrects the system static power value in responses to a change in temperature of the arithmetic processing devices, which is changed based on a variation of the system power upper limit, and
wherein the upper limit generation circuit generates dynamic power upper limits of each of the arithmetic processing devices using the system static power value corrected by the system static power value correction circuit.

8. The information processing apparatus according to claim 4,
wherein the upper limit generation circuit generates dynamic power upper limits of each of the arithmetic processing devices by subtracting a value obtained by dividing a job power upper limit, which is the upper limit of dynamic power consumed by an operation of arithmetic processing devices executing arithmetic processing among the plurality of arithmetic processing devices by the number of arithmetic processing devices executing arithmetic processing, from the value obtained by dividing the system static power value by the number of the plurality of arithmetic processing devices.

9. The information processing apparatus according to claim 2,
wherein the predetermined coefficient values respectively held by the plurality of coefficient value holding circuitry are set such that dynamic power consumed by an arithmetic processing device having an average electrical characteristic is represented by the accumulated value.

10. The information processing apparatus according to claim 3,
wherein the control device causes the plurality of arithmetic processing devices to execute arithmetic processing in a distributed manner and executes barrier synchronization that waits for completion of the arithmetic processing executed by the plurality of arithmetic processing devices in a distributed manner.

11. The information processing apparatus according to claim 2,
wherein the arithmetic processing device further includes a memory access control circuit configured to control access of a main memory connected to the arithmetic processing devices; and
a cache memory circuit configured to hold data stored in the main memory,
wherein each of the plurality of coefficient value holding circuitry holds each of the predetermined coefficient values corresponding to each of the events occurring according to processing executed by the arithmetic processing circuit, the memory access control circuit, and the cache memory circuit, and
wherein the accumulated value holding circuit holds an accumulated value obtained by respectively adding integrated values of a target event number which is the number of target events occurring according to processing executed by the arithmetic processing circuit, the memory access control circuit, and the cache memory circuit and coefficient values respectively held by the plurality of coefficient value holding circuitry

12. The information processing apparatus according to claim 2,
wherein the control circuit controls the voltage of the arithmetic processing devices such that the accumulated value held by the accumulated value holding circuit does not exceed the power upper limit held by the power upper limit holding circuit.

13. An arithmetic processing device comprising:
an arithmetic processing circuit configured to execute arithmetic processing and generate a plurality of event signals corresponding to events executed in the arithmetic processing;
a plurality of coefficient value holding circuitry respectively configured to hold a coefficient value corresponding to any one of events to be executed by the arithmetic processing circuit;
an accumulated value holding circuit configured to hold an accumulated value obtained by using one or more of the coefficient values held by specified coefficient value holding circuitry from among the plurality of coefficient value holding circuitry, the specified coefficient value holding circuitry corresponding to the plurality of event signals generated by the arithmetic processing circuit;
a power upper limit holding circuit configured to hold power upper limits of each arithmetic processing device which correspond to a system power upper limit which is the power upper limit of the information processing apparatus; and
a control circuit configured to control at least one of a voltage and a frequency of each of the arithmetic processing devices such that the accumulated value held by the accumulated value holding circuit does not exceed the power upper limit held by the power upper limit holding circuit.

14. The arithmetic processing device according to claim 13,
wherein the arithmetic processing device is configured to operate as any one of a plurality of arithmetic processing devices included in an information processing apparatus,
wherein the predetermined coefficient values respectively held by the plurality of coefficient value holding circuitry are commonly set in the plurality of arithmetic processing devices.

15. A method of controlling an information processing apparatus which includes a plurality of arithmetic processing devices that execute arithmetic processing, in which the plurality of arithmetic processing devices include an arithmetic processing circuit configured to execute arithmetic processing and generate a plurality of event signals corresponding to events executed in the arithmetic processing; a plurality of coefficient value holding circuitry respectively configured to hold a coefficient value corresponding to any one of events to be executed by the arithmetic processing circuit; a power upper limit holding circuit configured to hold power upper limits of each arithmetic processing device which correspond to a system power upper limit which is the power upper limit of the information processing apparatus; an accumulated value holding circuit; and a control circuit, the method comprising:
causing the accumulated value holding circuit to hold an accumulated value obtained by using one or more of the coefficient values held by specified coefficient value holding circuitry from among the plurality of coefficient value holding circuitry, the specified coefficient value holding circuitry corresponding to the plurality of event signals generated by the arithmetic processing circuit; and
causing the control circuit to control at least one of a voltage and a frequency of each of the arithmetic processing devices such that the accumulated value held by the accumulated value holding circuit does not exceed the power upper limit held by the power upper limit holding circuit.

16. The method according to claim 15,
wherein the predetermined coefficient values respectively held by the plurality of coefficient value holding circuitry are commonly set in the plurality of arithmetic processing devices.
